(19) United States
(12) Patent Application Publication
(10) Pub. No.: US 2026/0368645 A1
(43) Pub. Date: Nov. 19, 2026

(54) System, Method, and Computer Program Product for Managing Models and Mitigating Model Bias

(71) Applicant: Visa International Service Association, San Francisco, CA (US)

(72) Inventors: Yan-Kai Wei, Santa Clara, CA (US); Dong Hun Lee, San Ramon, CA (US); Tanping Wang, Los Altos, CA (US); Sam Peter Hamilton, Los Altos, CA (US); Ganesan V. Srinivasan, Santa Clara, CA (US)

(21) Appl. No.: 19/676,326

(22) Filed: May 13, 2026

Related U.S. Application Data
(60) Provisional application No. 63/804,906, filed on May 13, 2025.

(51) Int. Cl. G06N 20/00; G06F 18/21

(52) U.S. Cl. CPC G06N 20/00; G06F 18/217

(57) ABSTRACT

Systems, methods, and computer program products are provided for managing machine learning models and mitigating model bias. An example system includes a data storage device comprising model requirement data, at least one processor in communication with the data storage device, the at least one processor configured to: retrieve at least one parameter from the model requirement data based on a specified location, execute at least one machine-learning model based on input data to generate an output, generate a bias metric based on the output and the at least one parameter, determine a mitigation procedure based on the bias metric, and execute the mitigation procedure.

### CROSS REFERENCE TO RELATED APPLICATION

This application claims the benefit of U.S. Provisional Patent Application No. 63/804,906, filed May 13, 2025, the disclosure of which is hereby incorporated by reference in its entirety.

### BACKGROUND

### 1. Technical Field

This disclosure relates generally to machine-learning models and, in some non-limiting embodiments or aspects, to systems, methods, and computer program products for managing machine learning models and mitigating model bias.

### 2. Technical Considerations

Machine learning may refer to a field of computer science that uses statistical techniques to provide a computer system with the ability to learn (e.g., to progressively improve performance of) a task with data without the computer system being explicitly programmed to perform the task. In some instances, a machine learning model may be developed for a set of data so that the machine learning model may perform a task (e.g., a task associated with a prediction) with regard to the set of data. In some instances, a machine learning model may be used to classify an outcome with regard to a condition or an event. In such examples, a prediction provided by the machine learning model may include a probability that the occurrence of the condition will take place, where the probability has been generated based on the machine learning model being trained on a large dataset.

However, as machine learning model management requirements increase, systems that include manual operations and rely completely on user interactions may not be able to meet appropriate requirements with regard to model parameters and accessibility of machine learning models and associated data.

### SUMMARY

Accordingly, provided are improved systems, methods, and computer program products for managing machine learning models and mitigating model bias.

According to non-limiting embodiments or aspects, provided is a system comprising: a data storage device comprising model requirement data; at least one processor in communication with the data storage device, the at least one processor configured to: retrieve at least one parameter from the model requirement data based on a specified location; execute at least one machine-learning model based on input data to generate an output; generate a bias metric based on the output and the at least one parameter; determine a mitigation procedure based on the bias metric; and execute the mitigation procedure. In non-limiting embodiments or aspects, the system further comprises a software agent configured to retrieve the at least one parameter and execute the at least one machine-learning model, the input data is based at least partially on the at least one parameter. In non-limiting embodiments or aspects, the at least one processor is configured to automatically re-execute the at least one machine-learning model and automatically execute an updated mitigation procedure based on updates to the model requirement data.

According to non-limiting embodiments or aspects, provided is a method comprising: retrieving at least one parameter from the model parameter data based on a specified location; executing at least one machine-learning model based on input data to generate an output; generating a bias metric based on the output and the at least one parameter; determining a mitigation procedure based on the bias metric; and executing the mitigation procedure. According to non-limiting embodiments or aspects, provided is a computer program product comprising at least one non-transitory computer-readable medium including program instructions that, when executed by at least one processor, cause the at least one processor to perform the method.

According to non-limiting embodiments or aspects, provided is a system comprising at least one processor in communication with the data storage device, the at least one processor configured to: receive a request from a user device to register at least one policy, the request identifying the at least one policy and model data for at least one machine-learning model; retrieve, with a software agent, policy data corresponding to the at least one policy; determine a plurality of categories based on the policy data; generate a plurality of questions based on the plurality of categories; and generate answers to the plurality of questions based on the model data. According to non-limiting embodiments or aspects, provided is a method comprising: receiving a request from a user device to register at least one policy, the request identifying the at least one policy and model data for at least one machine-learning model; retrieving, with a software agent, policy data corresponding to the at least one policy; determining a plurality of categories based on the policy data; generating a plurality of questions based on the plurality of categories; and generating answers to the plurality of questions based on the model data. According to non-limiting embodiments or aspects, provided is a computer program product comprising at least one non-transitory computer-readable medium including program instructions that, when executed by at least one processor, cause the at least one processor to perform the method.

According to non-limiting embodiments or aspects, provided is a system comprising at least one processor in communication with a data storage device, the at least one processor configured to: search, with a first software agent, a ground truth repository based on model data provided by a user for a machine-learning model, resulting in a ground truth table; merge, with a second software agent, the ground truth table with a transaction table representing transaction data corresponding to at least one merchant, resulting in a merged table; validate, with a third software agent, the merged table; and provide access to the merged table via at least one interface. According to non-limiting embodiments or aspects, provided is a method comprising: searching, with a first software agent, a ground truth repository based on model data provided by a user for a machine-learning model, resulting in a ground truth table; merging, with a second software agent, the ground truth table with a transaction table representing transaction data corresponding to at least one merchant, resulting in a merged table; validating, with a third software agent, the merged table; and providing access to the merged table via at least one interface. According to non-limiting embodiments or aspects, provided is a computer program product comprising at least one non-transitory computer-readable medium including program instructions that, when executed by at least one processor, cause the at least one processor to perform the method.

According to non-limiting embodiments or aspects, provided is a system comprising at least one processor configured to: generate, with a first software agent, code corresponding to a plurality of tests; execute, with a second software agent, the code with a target model to generate at least one local output and at least one global output; validate, with a third software agent, the at least one local output and the at least one global output; and generate, with a fourth software agent, a report based on the at least one output, the report comprises at least one recommendation based on retrieving at least one data element and inputting the at least one element and the report into a generative model. According to non-limiting embodiments or aspects, provided is a method comprising: generating, with a first software agent, code corresponding to a plurality of tests; executing, with a second software agent, the code with a target model to generate at least one local output and at least one global output; validating, with a third software agent, the at least one local output and the at least one global output; and generating, with a fourth software agent, a report based on the at least one output, the report comprises at least one recommendation based on retrieving at least one data element and inputting the at least one element and the report into a generative model. According to non-limiting embodiments or aspects, provided is a computer program product comprising at least one non-transitory computer-readable medium including program instructions that, when executed by at least one processor, cause the at least one processor to perform the method.

According to non-limiting embodiments or aspects, provided is a system comprising at least one processor configured to: monitor, with a first software agent, a plurality of models associated with an entity by recording input and output data for the plurality of models over a plurality of executions; determine, with at least one second software agent, at least one of model drift and data drift for each model of the plurality of models; and determine, with a third software agent or the at least one second software agent, at least one recommended action to perform on at least one model of the plurality of models based on at least one of a seasonal event and an economic event. According to non-limiting embodiments or aspects, provided is a method comprising: monitoring, with a first software agent, a plurality of models associated with an entity by recording input and output data for the plurality of models over a plurality of executions; determining, with at least one second software agent, at least one of model drift and data drift for each model of the plurality of models; and determining, with a third software agent or the at least one second software agent, at least one recommended action to perform on at least one model of the plurality of models based on at least one of a seasonal event and an economic event. According to non-limiting embodiments or aspects, provided is a computer program product comprising at least one non-transitory computer-readable medium including program instructions that, when executed by at least one processor, cause the at least one processor to perform the method.

According to non-limiting embodiments or aspects, provided is a system comprising: at least one data storage device comprising model data associated with a plurality of models, the model data comprising at least one of the following: model metrics, model risk management, model policy, or any combination thereof; and at least one processor in communication with the data storage device, the at least one processor configured to: retrieve additional model data from at least one external system; store the additional model data in the at least one data storage device; generate a graphical user interface configured to display at least a portion of the model data stored in the at least one data storage device; and generate at least one report based on user interaction with the graphical user interface and the model data. According to non-limiting embodiments or aspects, provided is a method comprising: retrieving additional model data from at least one external system; storing the additional model data in the at least one data storage device; generating a graphical user interface configured to display at least a portion of the model data stored in the at least one data storage device; and generating at least one report based on user interaction with the graphical user interface and the model data. According to non-limiting embodiments or aspects, provided is a computer program product comprising at least one non-transitory computer-readable medium including program instructions that, when executed by at least one processor, cause the at least one processor to perform the method.

According to non-limiting embodiments or aspects, provided is a system comprising: at least one data storage device comprising model data associated with a plurality of models, the model data comprising at least one of the following: metadata, performance metrics, data drift metrics, reports, or any combination thereof; and at least one processor in communication with the data storage device, the at least one processor configured to: automatically retrieve additional model data; store the additional model data in the at least one data storage device; receive a user query; segment the user query into a plurality of subqueries; conduct a similarity search for each subquery based on the model data; form a plurality of model groups based on the similarity search; map relationships between model groups of the plurality of model groups; and generate a graphical user interface based on the mapped relationships. According to non-limiting embodiments or aspects, provided is a method comprising: automatically retrieving additional model data; storing the additional model data in at least one data storage device; receiving a user query; segmenting the user query into a plurality of subqueries; conducting a similarity search for each subquery based on the model data; forming a plurality of model groups based on the similarity search; mapping relationships between model groups of the plurality of model groups; and generating a graphical user interface based on the mapped relationships. According to non-limiting embodiments or aspects, provided is a computer program product comprising at least one non-transitory computer-readable medium including program instructions that, when executed by at least one processor, cause the at least one processor to perform the method.

Further non-limiting embodiments or aspects are set forth in the following numbered clauses:
Clause 1: A system comprising: a data storage device comprising model requirement data; at least one processor in communication with the data storage device, the at least one processor configured to: retrieve at least one parameter from the model requirement data based on a specified location; execute at least one machine-learning model based on input data to generate an output; generate a bias metric based on the output and the at least one parameter; determine a mitigation procedure based on the bias metric; and execute the mitigation procedure.
Clause 2: The system of clause 1, further comprising a software agent configured to retrieve the at least one parameter and execute the at least one machine-learning model, wherein the input data is based at least partially on the at least one parameter.
Clause 3: The system of any of clauses 1-2, wherein the at least one processor is configured to automatically re-execute the at least one machine-learning model and automatically execute an updated mitigation procedure based on updates to the model requirement data.
Clause 4: A method comprising: retrieving at least one parameter from the model parameter data based on a specified location; executing at least one machine-learning model based on input data to generate an output; generating a bias metric based on the output and the at least one parameter; determining a mitigation procedure based on the bias metric; and executing the mitigation procedure.
Clause 5: A computer program product comprising at least one non-transitory computer-readable medium including program instructions that, when executed by at least one processor, cause the at least one processor to perform the method of clause 4.
Clause 6: A system comprising at least one processor in communication with the data storage device, the at least one processor configured to: receive a request from a user device to register at least one policy, the request identifying the at least one policy and model data for at least one machine-learning model; retrieve, with a software agent, policy data corresponding to the at least one policy; determine a plurality of categories based on the policy data; generate a plurality of questions based on the plurality of categories; and generate answers to the plurality of questions based on the model data.
Clause 7: A method comprising: receiving a request from a user device to register at least one policy, the request identifying the at least one policy and model data for at least one machine-learning model; retrieving, with a software agent, policy data corresponding to the at least one policy; determining a plurality of categories based on the policy data; generating a plurality of questions based on the plurality of categories; and generating answers to the plurality of questions based on the model data.
Clause 8: A computer program product comprising at least one non-transitory computer-readable medium including program instructions that, when executed by at least one processor, cause the at least one processor to perform the method of clause 7.
Clause 9: A system comprising at least one processor in communication with a data storage device, the at least one processor configured to: search, with a first software agent, a ground truth repository based on model data provided by a user for a machine-learning model, resulting in a ground truth table; merge, with a second software agent, the ground truth table with a transaction table representing transaction data corresponding to at least one merchant, resulting in a merged table; validate, with a third software agent, the merged table; and provide access to the merged table via at least one interface.
Clause 10: A method comprising: searching, with a first software agent, a ground truth repository based on model data provided by a user for a machine-learning model, resulting in a ground truth table; merging, with a second software agent, the ground truth table with a transaction table representing transaction data corresponding to at least one merchant, resulting in a merged table; validating, with a third software agent, the merged table; and providing access to the merged table via at least one interface.
Clause 11: A computer program product comprising at least one non-transitory computer-readable medium including program instructions that, when executed by at least one processor, cause the at least one processor to perform the method of clause 10.
Clause 12: A system comprising at least one processor configured to: generate, with a first software agent, code corresponding to a plurality of tests; execute, with a second software agent, the code with a target model to generate at least one local output and at least one global output; validate, with a third software agent, the at least one local output and the at least one global output; and generate, with a fourth software agent, a report based on the at least one output, wherein the report comprises at least one recommendation based on retrieving at least one data element and inputting the at least one element and the report into a generative model.
Clause 13: A method comprising: generating, with a first software agent, code corresponding to a plurality of tests; executing, with a second software agent, the code with a target model to generate at least one local output and at least one global output; validating, with a third software agent, the at least one local output and the at least one global output; and generating, with a fourth software agent, a report based on the at least one output, wherein the report comprises at least one recommendation based on retrieving at least one data element and inputting the at least one element and the report into a generative model.
Clause 14: A computer program product comprising at least one non-transitory computer-readable medium including program instructions that, when executed by at least one processor, cause the at least one processor to perform the method of clause 13.
Clause 15: A system comprising at least one processor configured to: monitor, with a first software agent, a plurality of models associated with an entity by recording input and output data for the plurality of models over a plurality of executions; determine, with at least one second software agent, at least one of model drift and data drift for each model of the plurality of models; and determine, with a third software agent or the at least one second software agent, at least one recommended action to perform on at least one model of the plurality of models based on at least one of a seasonal event and economic event.
Clause 16: A method comprising: monitoring, with a first software agent, a plurality of models associated with an entity by recording input and output data for the plurality of models over a plurality of executions; determining, with at least one second software agent, at least one of model drift and data drift for each model of the plurality of models; and determining, with a third software agent or the at least one second software agent, at least one recommended action to perform on at least one model of the plurality of models based on at least one of a seasonal event and economic event.
Clause 17: A computer program product comprising at least one non-transitory computer-readable medium including program instructions that, when executed by at least one processor, cause the at least one processor to perform the method of clause 16.
Clause 18: A system comprising: at least one data storage device comprising model data associated with a plurality of models, the model data comprising at least one of the following: model metrics, model risk management, model policy, or any combination thereof; and at least one processor in communication with the data storage device, the at least one processor configured to: retrieve additional model data from at least one external system; store the additional model data in the at least one data storage device; generate a graphical user interface configured to display at least a portion of the model data stored in the at least one data storage device; and generate at least one report based on user interaction with the graphical user interface and the model data.
Clause 19: A method comprising: retrieving additional model data from at least one external system; storing the additional model data in the at least one data storage device; generating a graphical user interface configured to display at least a portion of the model data stored in the at least one data storage device; and generating at least one report based on user interaction with the graphical user interface and the model data.
Clause 20: A computer program product comprising at least one non-transitory computer-readable medium including program instructions that, when executed by at least one processor, cause the at least one processor to perform the method of clause 19.
Clause 21: A system comprising: at least one data storage device comprising model data associated with a plurality of models, the model data comprising at least one of the following: metadata, performance metrics, data drift metrics, reports, or any combination thereof; and at least one processor in communication with the data storage device, the at least one processor configured to: automatically retrieve additional model data; store the additional model data in the at least one data storage device; receive a user query; segment the user query into a plurality of subqueries; conduct a similarity search for each subquery based on the model data; form a plurality of model groups based on the similarity search; map relationships between model groups of the plurality of model groups; and generate a graphical user interface based on the mapped relationships.
Clause 22: A method comprising: automatically retrieving additional model data; storing the additional model data in at least one data storage device; receiving a user query; segmenting the user query into a plurality of subqueries; conducting a similarity search for each subquery based on the model data; forming a plurality of model groups based on the similarity search; mapping relationships between model groups of the plurality of model groups; and generating a graphical user interface based on the mapped relationships.
Clause 23: A computer program product comprising at least one non-transitory computer-readable medium including program instructions that, when executed by at least one processor, cause the at least one processor to perform the method of clause 22.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for managing machine learning models and mitigating model bias, according to some non-limiting embodiments or aspects;

FIG. 2 is a schematic diagram of a system architecture of a machine learning (ML) bias management system, according to some non-limiting embodiments or aspects;

FIG. 3 is a flow diagram for a process for detecting and mitigating bias in a machine learning model, according to some non-limiting embodiments or aspects;

FIG. 4 is a schematic diagram of a system architecture of an ML model explainability system, according to some non-limiting embodiments or aspects;

FIG. 5 is a flow diagram for a process for providing model explainability information regarding a machine learning model, according to some non-limiting embodiments or aspects;

FIG. 6 is a schematic diagram of a system architecture of a ground truth (GT) provisioning system, according to some non-limiting embodiments or aspects;

FIG. 7 is a flow diagram for a process for providing a ground truth framework for a plurality of machine learning models, according to some non-limiting embodiments or aspects;

FIG. 8 is a schematic diagram of a system architecture of a ML model monitoring system, according to some non-limiting embodiments or aspects;

FIG. 9 is a flow diagram for a process for drift monitoring of machine learning models, according to some non-limiting embodiments or aspects;

FIG. 10 is a schematic diagram of a system architecture of a ML model discovery system, according to some non-limiting embodiments or aspects;

FIG. 11 is a flow diagram for a process for providing complex information regarding a plurality of machine learning models, according to some non-limiting embodiments or aspects;

FIG. 12 is a diagram of an exemplary environment in which systems, methods, and/or computer program products, described herein, may be implemented, according to some non-limiting embodiments or aspects; and

FIG. 13 is a schematic diagram of example components of one or more devices of FIG. 1 and/or FIG. 12, according to some non-limiting embodiments or aspects.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second units. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers configured to process online payment transactions through webpages, mobile applications, and/or the like.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, POS devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to systems, methods, and computer program products for managing machine learning models and mitigating model bias. In some non-limiting embodiments or aspects, a system and method for monitoring one or more models is provided. In some implementations of multiple machine-learning models, there may not be a single location to monitor. Different services in a firm monitor various metrics, and there may not be a single location to manage these models. In some non-limiting embodiments or aspects, an artificial intelligence (AI) agent may be provided to monitor model drift and data drift. Users may interact with the AI agent to request monitoring and calculation of various metrics. Dedicated agents may perform tasks, such as drift detection and metrics calculation. In some examples, the AI agent may find optimal metrics on behalf of users. Some embodiments may also analyze detected issues and suggest recommended actions in real-time, considering seasonal events and/or economic situations. A web-based graphical user interface may provide a single portal for managing multiple models. An AI agent can create code to detect drift and calculate metrics. An AI agent may calculate drift scores and various metrics based on the analysis. Additionally, the AI agent provides recommended actions considering seasonal events and economic situations, including the generation of human-readable reports containing the analysis and recommendations.

In some non-limiting embodiments or aspects, a system for detecting and/or mitigating bias in machine-learning models is provided. Such a system may centralize model information management and support informed business decision-making, enable performance monitoring and lifecycle management for all models within a firm/organization, offer responsible AI services, including fairness, explainability, and model robustness, and leverage AI agent technologies for responsible AI services, ensuring the AI agent validates that the developed model complies with local regulations and acts before use.

In some non-limiting embodiments or aspects, a model fairness agent is provided that leverages multiple software agents and workflows, including detecting a model bias and providing a report, generating a fairness score and detailed impact analysis for the detected bias (e.g., using a large language model (LLM) or the like), providing a bias recommendation algorithm (e.g., using an LLM or the like), determining a mitigation algorithm for the detected bias, execute the mitigation action to result in a mitigated model and compare the mitigated model to the biased model, and execute a further mitigation action to consider regional regulations and generate a final report (e.g., using an LLM or the like).

In some non-limiting embodiments or aspects, the following functionality may be provided:

Centralized Management: non-limiting embodiments may provide model information, various metrics, responsible AI, and risk management in a single place by connecting to multiple data sources and services. Non-limiting embodiments may leverage AI agents to manage tasks and generate reports.

Integration with Other Services: non-limiting embodiments may fetch model information from different data sources. Along with user input, the system displays detailed model information. The system may collect all model metrics from various sources and display model information in real-time while also calculating these metrics.

Centralized Service: non-limiting embodiments may offer detailed model information, performance metrics, and data metrics all together. Non-limiting embodiments may also provide metrics value changes over time.

Responsible AI Framework: non-limiting embodiments may include fairness capabilities, such as bias detection, mitigation, and report generation. Non-limiting embodiments may maintain a database of local regulations and acts, using them to ensure model fairness. Additionally, non-limiting embodiments may provide model explainability features, such as local interpretation, global interpretation, and report generation.

Risk Management: non-limiting embodiments may automate the model risk checking process and provide a risk management framework to ensure model safety and security. AI Law/Act Analysis: non-limiting embodiments may collect AI laws and acts from each region and create a compliance matrix and risk matrix for use with non-limiting embodiments.

In AI model discovery, traditional two-dimensional relational databases (RDBs) are efficient for searching names and descriptions. However, such RDBs struggle to handle complicated queries and uncover complex relationships between data models, especially when trying to visualize these relationships. The following are some examples of queries where RDBs fall short: 1) Complex Relationship Discovery (e.g., find authentication models deployed in the EU with a high fairness score and categorize the results by risk levels as defined by the EU AI Act, identify all models that use datasets with the same demographic information and show the relationships among the models by demographic group, etc.); and 2) Data Analysis and Visualization (e.g., discover models experiencing high volatility in data drift with an average model accuracy above 80% over the past year and display the output by model usage, locate all models with a performance above 90% over the past year and group them by regions and model algorithm, etc.). In some non-limiting embodiments or aspects, a dynamic retrieval-augmented generation (RAG) system is provided that collects and organizes all model-related data such as, but not limited to metadata, performance metrics, data drift metrics, fairness reports, and risk analysis reports, with real-time updates. An AI agent may analyze incoming user queries, break them into manageable parts, and use advanced similarity search methods to find relevant information iteratively. An LLM model or other machine-learning model within the AI agent may then group the outputs based on similarity criteria (e.g., such as k-means clustering by demographics, regions, algorithm types, etc.) and map relationships using graph analysis techniques. The results may be presented through an interactive visualization tool in a graphical user interface.

Many countries are enacting and updating laws, acts, and regulations for General AI and AI technologies. Tracking these new and updated regulations is challenging. Even when an entity tracks these laws, acts, and regulations, they still need to understand and classify them before applying them in AI fairness, security, privacy, and safety. Finally, each law, act, and regulation must be converted into a form that can be used for AI model validation. In some non-limiting embodiments or aspects, an AI agent searches for and collects new and updated laws, acts, and regulations for each country. This AI agent analyzes and classifies these laws, acts, and regulations into categories related to fairness, security, privacy, and safety. The AI agent creates test cases for each category to validate the AI models.

In implementations of machine-learning models, no consolidated service is available to provide ground truth information to the data scientists. Collecting transaction information is difficult since it is located in different locations. In some non-limiting embodiments or aspects, a consolidated ground truth framework is provided using an AI agent. For example, a user can create ground truth data with transaction data and TC40 (e.g., an issuer-created fraud repository or data) for the given model in the ground truth framework. In some non-limiting embodiments or aspects, a user can get the ground truth data for the given model in the ground truth framework with natural language. Non-limiting embodiments may be implemented with the following software agents: Collector Agent: Search ground truth table and prioritize the result; Merger Agent: Automatically merge transaction table and ground truth table using various methods; Validator Agent: Verify the merged table and create the validation report; and Serving Agent: Automatically update ground truth catalog, create an application programming interface (API) and update a software development kit (SDK).

In some non-limiting embodiments or aspects, a model explainability agent is provided. To run model explainability, significant domain knowledge and coding skills are often required. Without a good understanding of model explainability, users cannot choose the right explainer (e.g., function for explaining a particular model). Even if users choose the correct explainer, they will have difficulty understanding the generated model explainability report. In some non-limiting embodiments or aspects, multiple AI models are provided that are configured to collaborate to generate the model explainability. The AI agents may provide both local interpretation and global interpretation. In some non-limiting embodiments or aspects, a Builder Agent generates code to run tests, and Executor Agent runs the generated code against the target model, a Validator Agent reviews the output from the Executors, a Writer Agent generates the model explainability report, a Reviewer Agent provides critique on the generated report, and the AI agent(s) may have a memory feature to keep track of all the activity and output.

In this way, the disclosed subject matter may provide for software agents that behave in a way that is designed for a specific individual, which may seek to deploy a software agent. Further, the software agent may be configured to act based on information associated with the individual and access to the software agent and the information associated with the individual may be kept in a secure fashion. Furthermore, the disclosed subject matter may provide for the software agent to perform actions only as requested by the individual, so that the network resources are conversed based on the functions of the software agent. Accordingly, the disclosed subject matter is unique and unconventional.

For the purpose of illustration, in the following description, while the presently disclosed subject matter is described with respect to systems, methods, and computer program products for managing machine learning models and mitigating model bias, one skilled in the art will recognize that the disclosed subject matter may be used with a wide variety of settings, such as tasks to be carried out by a software agent, that are used for making determinations (e.g., predictions, classifications, regressions, inferences, and/or the like) based on a dataset, such as for fraud detection/prevention, authorization, authentication, identification, product recommendation, and/or the like.

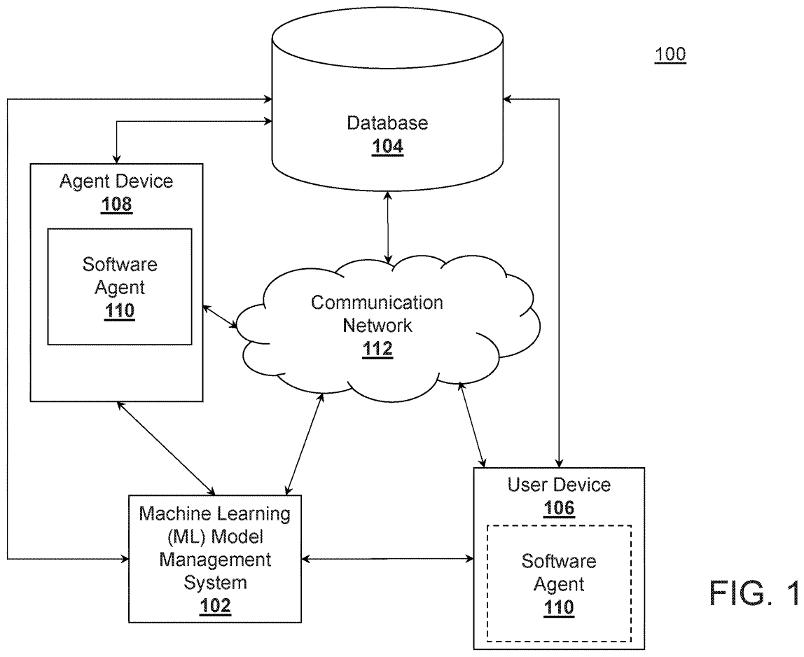

Referring now to FIG. 1, shown is system 100 for managing machine learning models and mitigating model bias, according to some non-limiting embodiments or aspects. For example, system 100 may include machine learning (ML) model management system 102, database 104, user device 106, agent device 108, software agent 110, and communication network 112.

ML model management system 102 may include one or more devices capable of receiving information from and/or communicating information to database 104 and/or user device 106 (e.g., directly via wired or wireless communication connection, indirectly via communication network 112, and/or the like). For example, ML model management system 102 may include a computing device, such as a server, a group of servers, a desktop computer, a portable computer, a mobile device, and/or other like devices. In some non-limiting embodiments or aspects, ML model management system 102 may be in communication with a data storage device (e.g., database 104), which may be local or remote to ML model management system 102. In some non-limiting embodiments or aspects, ML model management system 102 may be capable of receiving information from, storing information in, communicating information to, or searching information stored in the data storage device (e.g., database 104).

In some non-limiting embodiments or aspects, ML model management system 102 may receive a dataset (e.g., a training dataset) that includes a plurality of data records having a plurality of features. In some non-limiting embodiments or aspects, ML model management system 102 may receive a dataset that includes a plurality of data records, and each data record may include a plurality of features. In some non-limiting embodiments or aspects, each data record may be associated with a plurality of features. In some examples, the plurality of features may include a large number of features (e.g., a large number of features in a range between two values), such as 130 features, 100 features, 1300 features, 1,000 features, 13,000 features, 10,000 features, 100,000 features, and/or the like. In some non-limiting embodiments or aspects, the plurality of data records may include the data associated with the consumer, which may include historical transaction data associated with the consumer, AI data associated with the consumer, and/or trigger data associated with the consumer. Accordingly, the plurality of features of each data record may correspond to historical transaction data associated with the consumer, AI data associated with the consumer, and/or trigger data associated with the consumer.

In some non-limiting embodiments or aspects, the dataset may include a plurality of data records associated with a plurality of historical transactions (e.g., electronic payment transactions). In some examples, the dataset may include a large amount of data records, such as 100 data records, 1300 data records, 1,000 data records, 13,000 data records, 10,000 data records, 213,000 data records, 130,000 data records, 100,000 data records, 1,000,000 data records, and/or the like.

In some non-limiting embodiments or aspects, the plurality of data records may represent a plurality of historical transactions conducted by one or more entities, such as the consumer for which an software agent is to be based upon and/or one or more accountholders (e.g., one or more users, such as a user associated with user device 106), such as one or more accountholders that are determined to be similar to the consumer. In some non-limiting embodiments or aspects, a value of a feature of a data record may correspond to a value of transaction data associated with a payment transaction. For example, the value of a feature may correspond to a value of a data field in a record of a payment transaction. In some non-limiting embodiments or aspects, the plurality of features may include one or more features that correspond to transaction data (e.g., a parameter of transaction data, such as a data field in a record of a payment transaction) associated with a payment transaction. For example, the plurality of features may include a transaction amount associated with an amount of the payment transaction (e.g., a cost associated with the payment transaction, a transaction amount, an overall transaction amount, a cost of one or more products involved in the payment transaction, and/or the like), a transaction value associated with a number of payment transactions, a transaction time associated with a time interval at which the payment transaction occurred (e.g., a timestamp that includes a time of day, a day of the week, a date of a month, a month of a year, a predetermined time of day segment, such as morning, afternoon, evening, night, and/or the like, a predetermined day of the week segment, such as weekday, weekend, and/or the like, a predetermined segment of a year, such as first quarter, second quarter, and/or the like), a transaction type of the payment transaction (e.g., an online transaction, a card present transaction, a face-to-face transaction, an electronic commerce indicator, a settlement flag for a payment transaction, and/or the like), an account identifier (e.g., a PAN) of an account involved in the payment transaction, a merchant identifier (e.g., a merchant name) of a merchant involved in the payment transaction, a merchant category code of a merchant involved in the payment transaction, and/or the like.

In some non-limiting embodiments or aspects, the transaction data associated with the payment transactions may include values of a plurality of data fields associated with the payment transactions. The values of the plurality of data fields may include values of one or more transaction amount data fields associated with an amount of the payment transaction (e.g., a cost associated with the payment transaction, a transaction amount, an overall transaction amount, a cost of one or more products involved in the payment transaction, and/or the like), values of one or more transaction time data fields associated with a time interval at which the payment transaction occurred (e.g., a time of day, a day of the week, a date of a month, a month of a year, a predetermined time of day segment such, as morning, afternoon, evening, night, and/or the like, a predetermined day of the week segment, such as weekday, weekend, and/or the like, a predetermined segment of a year, such as first quarter, second quarter, and/or the like), values of one or more transaction type data fields associated with a transaction type of the payment transaction (e.g., an online transaction, a card present transaction, a face-to-face transaction, an electronic commerce indicator, a settlement flag for a payment transaction, and/or the like), and/or the like.

Database 104 may include one or more devices capable of receiving information from and/or communicating information to ML model management system 102, user device 106, and/or agent device 108 (e.g., directly via wired or wireless communication connection, indirectly via communication network 112, and/or the like). For example, database 104 may include a computing device, such as a server, a group of servers, a desktop computer, a portable computer, a mobile device, and/or other like devices. In some non-limiting embodiments or aspects, database 104 may include a data storage device. In some non-limiting embodiments or aspects, database 104 may be capable of receiving information from, storing information in, communicating information to, or searching information stored in the data storage device. In some non-limiting embodiments or aspects, database 104 may be part of ML model management system 102 and/or part of the same system as ML model management system 102.

User device 106 may include one or more devices capable of receiving information from and/or communicating information to ML model management system 102, database 104, and/or agent device 108 (e.g., directly via wired or wireless communication connection, indirectly via communication network 112, and/or the like). For example, user device 106 may include a computing device, such as a mobile device, a portable computer, a desktop computer, and/or other like devices. Additionally or alternatively, each user device 106 may include a device capable of receiving information from and/or communicating information to other user devices 106 (e.g., directly via wired or wireless communication connection, indirectly via communication network 112, and/or the like). In some non-limiting embodiments or aspects, user device 106 may be part of ML model management system 102 and/or part of the same system as ML model management system 102. For example, ML model management system 102, database 104, and user device 106 may all be (and/or be part of) a single system and/or a single computing device. In some non-limiting embodiments or aspects, user device 106 may be a client device of agent device 108.

Agent device 108 may include one or more devices capable of receiving information from and/or communicating information to ML model management system 102, database 104, and/or user device 106 (e.g., directly via wired or wireless communication connection, indirectly via communication network 112, and/or the like). For example, agent device 108 may include a computing device, such as a server (e.g., a web server), a group of servers, a desktop computer, a portable computer, a mobile device, and/or other like devices. In some non-limiting embodiments or aspects, agent device 108 may include software agent 110 stored thereon. For example, agent device 108 may include the necessary hardware to allow for software agent 110 to function.

Software agent 110 (e.g., each software agent of a plurality of software agents 110) may include a computational entity that is capable of perceiving an environment of the computational entity through inputs. In some non-limiting embodiments or aspects, software agent 110 may maintain an internal state and may select one or more actions to achieve a specific objective (e.g., an objective specified according to a decision policy, upon which software agent 110 may be trained). In some non-limiting embodiments or aspects, software agent 110 may be a component of user device 106 and/or agent device 108. In some non-limiting embodiments or aspects, software agent 110 may be stored on a device that is separate from user device 106 and/or agent device 108. In some non-limiting embodiments or aspects, software agent 110 may be configured to operate autonomously (e.g., without continuous human control), to respond to environmental inputs, to take goal-directed actions, and not simply reactive actions, maintain internal context (e.g., memory), and perform actions determined by a mapping from state to action.

In some non-limiting embodiments or aspects, a software agent (e.g., a software agent) may be a computer program that acts for an entity (e.g., a user or another computer program) in a relationship of agency. In some instances, a software agent may have the authority to decide (e.g., on behalf on the entity with which the software agent has an agency relationship) which, if any, action is appropriate. A software agent may be colloquially referred to as a bot, which comes from the word robot. The software agent may include a physical manifestation, as when execution of an action of the software agent is paired with an action of a device, such as a robot body. In some instances, the software agent may include a service without a physical manifestation, such as a virtual assistant executing on a mobile device (e.g., a chatbot executing on a smartphone), or other computing device. Software agents may be autonomous or work together with other software agents or other users (e.g., human beings, people, individuals, and/or the like). In some instances, a software agent may interact with users, for example, in human-robot interaction environments, and the software agent may possess human-like qualities, such as natural language understanding, speech, personality, and/or a humanoid form.

Communication network 112 may include one or more wired and/or wireless networks. For example, communication network 112 may include a cellular network (e.g., a long-term evolution (LTE®) network, a third generation (3G) network, a fourth generation (4G) network, a fifth generation (13G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

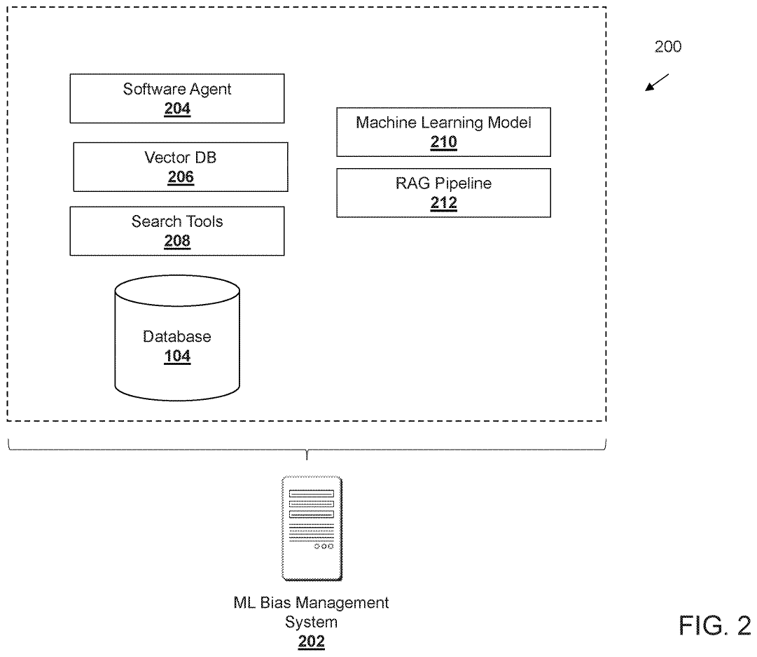

Referring now to FIG. 2, shown is a schematic diagram of exemplary system architecture 200 of ML bias management system 202 for detecting and mitigating bias in a machine learning model, according to some non-limiting embodiments or aspects. In some non-limiting embodiments or aspects, one or more components of architecture 200 may be included in ML bias management system 202. In some non-limiting embodiments or aspects, one or more of the components of system architecture 200 may be (e.g., completely, partially, etc.) a component of another device or a group of devices separate from or including ML bias management system 202, such as ML model management system 102, database 104, user device 106, and/or agent device 108. In some non-limiting embodiments or aspects, ML bias management system 202 may be the same as or similar to ML model management system 102.

As shown in FIG. 2, system architecture 200 of ML bias management system 202 may include software agent 204, vector database (DB) 206, search tools 208, machine learning model 210, retrieval-augmented generation (RAG) pipeline 212, and database 104. In some non-limiting embodiments or aspects, software agent 204 may orchestrate an entire bias detection and mitigation workflow. In some non-limiting embodiments or aspects, database 104 may store bias detection and mitigation results. In some non-limiting embodiments or aspects, search tools 208 may find a mitigation algorithm (e.g., the most effective mitigation algorithm) within software agent 204. In some non-limiting embodiments or aspects, machine learning model 210 may include a large language model (LLM) that analyzes mitigation results and/or generates a final report. In some non-limiting embodiments or aspects, vector DB 206 stores country-specific fairness requirements for RAG retrieval. In some non-limiting embodiments or aspects, RAG pipeline 212 creates, updates, and/or retrieves fairness requirements in Vector DB 206.

In some non-limiting embodiments or aspects, ML bias management system 202 may evaluate model fairness through statistical fairness measures across one or more sensitive attributes (e.g., gender, age, and/or race) as defined by applicable regional regulations. In some non-limiting embodiments or aspects, ML bias management system 202 may receive model information (e.g., data location and/or risk level) and specify fairness and/or performance metrics to evaluate, and may set one or more acceptable bias ratios (e.g., 10%).

In some non-limiting embodiments or aspects, ML bias management system 202 may use a RAG to retrieve country-specific fairness requirements and sensitive attribute definitions from a vector database (e.g., vector DB 206). For example, for a high-risk model deployed (e.g., in a country, such as Italy, or group of countries, such as the European Union (EU)), ML bias management system 202 may retrieve one or more requirements, such as non-discrimination in credit scoring, and may identify one or more sensitive attributes including sex, age, and/or race.

In some non-limiting embodiments or aspects, ML bias management system 202 may run a bias detection job that may assess model output against a retrieved fairness requirement, thereby producing one or more per-attribute metrics (e.g., maximum and/or minimum values across demographic groups).

In some non-limiting embodiments or aspects, ML bias management system 202 may, for each of the one or more sensitive attributes, record the maximum and/or minimum values across one or more groups. In some non-limiting embodiments or aspects, a range (e.g., maximum to minimum) may quantify a degree of bias for the one or more sensitive attributes. In some non-limiting embodiments or aspects, ML bias management system 202 may output a bias detection report with one or more of the aforementioned values and/or the degree of bias.

In some non-limiting embodiments or aspects, when ML bias management system 202 identifies bias, ML bias management system 202 may select and apply one or more mitigation algorithms. In some non-limiting embodiments or aspects, a mitigation algorithm may include a reweighing algorithm. In some non-limiting embodiments or aspects, a reweighing algorithm may adjust one or more weights of one or more training samples to, for example, reduce bias in training data. In some non-limiting embodiments or aspects, a mitigation algorithm may include a disparate impact remover (DIR). In some non-limiting embodiments or aspects, a DIR may modify one or more feature values to remove one or more correlations with one or more of the sensitive attributes. In some non-limiting embodiments or aspects, the DIR may modify one or more feature values to remove one or more correlations with one or more of the sensitive attributes while preserving rank ordering. In some non-limiting embodiments or aspects, a mitigation algorithm may include an adversarial debiasing (AD) algorithm. In some non-limiting embodiments or aspects, an AD algorithm may include the application of an adversarial network during training to minimize a model's ability to predict one or more sensitive attributes from an output. In some non-limiting embodiments or aspects, a mitigation algorithm may include an equalized odds (EO) algorithm. An EO algorithm may include a post-processing technique that adjusts model predictions to equalize true positive and false positive rates across groups. In some non-limiting embodiments or aspects, a mitigation algorithm may include a fairness constraint optimization (FCO) algorithm. An FCO algorithm may apply one or more optimization constraints that may target and minimize bias in one or more sensitive attributes to ensure regulatory compliance.

A non-limiting example of a before/after comparison of a biased model and a mitigated model is shown below in Table 1:

TABLE 1

| | | | | Post- | Post- | Post- | |
|---|---|---|---|---|---|---|---|
| Sensitive | Original | Original | Original | Mitigation | Mitigation | Mitigation | |
| Attribute | Max | Min | Range | Max | Min | Range | Status |
| Gender | 0.8 | 0.2 | 0.6 | 0.0 | 0.0 | 0.0 | Bias |
| | | | | | | | removed |
| Age | 0.9 | 0.4 | 0.5 | 0.85 | 0.5 | 0.35 | Bias |
| | | | | | | | mitigated |
| Race | 0.7 | 0.3 | 0.4 | 0.65 | 0.35 | 0.3 | Bias |
| | | | | | | | mitigated |

In some non-limiting embodiments or aspects, ML bias management system 202 may generate an overall fairness score using the formula below:

Fairness score=SUM over all sensitive attributes of ((max_value−min_value)/max_value)*100

In one example, a fairness score for the example in Table 1 may be calculated, using the formula above as 83.35, indicating a degree of fairness achieved after mitigation.

In some non-limiting embodiments or aspects, ML bias management system 202 may analyze an outputted bias detection report with a machine learning model, for example a large language model (LLM), for example, with an LLM prompt. In some non-limiting embodiments or aspects, ML bias management system 202 may extract one or more identified biases per sensitive attribute, retrieve one or more mitigation algorithms as described above (e.g., with associated risk rankings), and select an optimal mitigation algorithm for each bias type.

In some non-limiting embodiments or aspects, ML bias management system 202 may maintain a dynamic RAG pipeline with a vector DB, where the vector DB may store fairness requirements for one or more countries. In some non-limiting embodiments or aspects, ML bias management system 202 may store one or more country-specific fairness requirements and one or more sensitive attribute definitions in the vector DB (e.g., EU Artificial Intelligence Act requirements for high-risk models specifying “no bias” for gender and “bias allowed within 0.1 range” for age and race). In some non-limiting embodiments or aspects, ML bias management system 202 may query the vector DB using RAG with one or more parameters, including, for example, law name, model name, risk level, and/or deployment country. In some non-limiting embodiments or aspects, ML bias management system 202 may continuously search for and, if applicable, update the vector DB with changes in country-specific regulations, thereby ensuring that ML bias management system 202 remains compliant with evolving standards over time.

In some non-limiting embodiments or aspects, following mitigation of bias, ML bias management system 202 may perform an automated compliance check. In some non-limiting embodiments or aspects, ML bias management system 202 may load relevant regulations for deployment regions (e.g., deployment of one or more machine learning models into regions defined based on recognized boundaries, recognized legal requirements, recognized demographics, etc.) using RAG. In some non-limiting embodiments or aspects, ML bias management system 202 may compare metric ranges (e.g., post-mitigation metric ranges) against one or more regulatory thresholds (e.g., EU Artificial Intelligence Act requires “no bias” for gender in high-risk models and bias within 0.1 range for age and race). In some non-limiting embodiments or aspects, ML bias management system 202 may, upon determining that one or more results of a machine learning model do not comply with one or more regulatory requirements, automatically retrigger mitigation with one or more alternative mitigation algorithms (e.g., from those described above). In some non-limiting embodiments or aspects, ML bias management system 202 may output a compliance standard per sensitive attribute (e.g., compliant or non-compliant) and, if a re-run is triggered, ML bias management system 202 may identify an alternative mitigation algorithm and a rationale for selection of the one or more alternative mitigation algorithms.

In some non-limiting embodiments or aspects, ML bias management system 202 may output a final fairness report using an LLM. In some non-limiting embodiments or aspects, a final fairness report may include one or more of a description of the model used (e.g., name, description, risk level, and/or deployment country), law requirements (e.g., applicable regulatory fairness requirements retrieved via RAG), one or more sensitive attributes set by law (e.g., one or more sensitive attributes defined by one or more applicable regulations), a bias detection report (e.g., an original bias metric per sensitive attribute), a bias removal status (e.g., a comparison of pre- and post-mitigation metrices, for example, with an assessment of whether a bias was removed or mitigated), mitigation algorithm(s) used (e.g., a description of each mitigation algorithm applied and a rationale for its selection), a further recommendation (e.g., a recommendation for model retraining and/or additional mitigation steps), and/or a conclusion (e.g., an overall fairness score, compliance status, and/or a summary of a mitigation outcome).

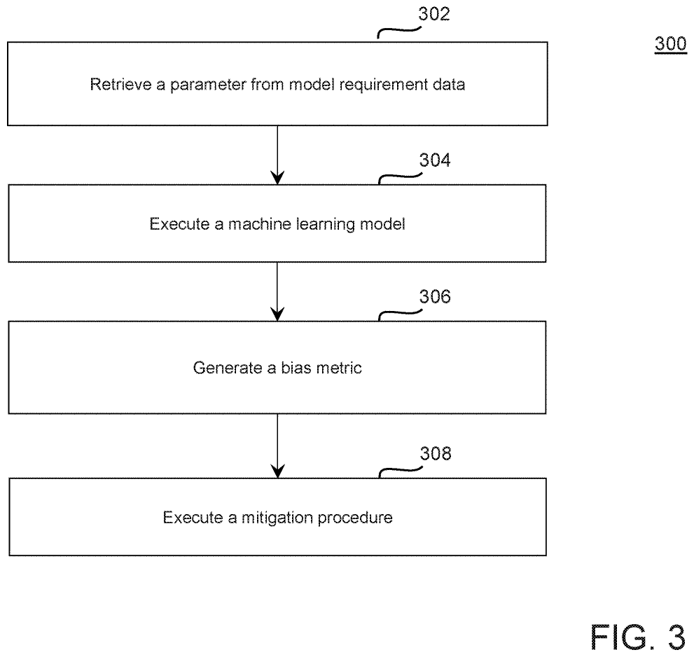

Referring now to FIG. 3, shown is a flow diagram for process 300 for detecting and mitigating bias in a machine learning model, according to some non-limiting embodiments or aspects. The steps shown in FIG. 3 are for example purposes only. It will be appreciated that additional, fewer, different, and/or different order of steps may be used in non-limiting embodiments or aspects. In some non-limiting embodiments or aspects, a step may be automatically performed in response to performance and/or completion of a prior step. In some non-limiting embodiments or aspects, one or more of the steps of process 300 may be performed (e.g., completely, partially, and/or the like) by ML bias management system 202 (e.g., at least one component of ML bias management system 202, as shown in FIG. 2). In some non-limiting embodiments or aspects, one or more of the steps of process 300 may be performed (e.g., completely, partially, and/or the like) by another system, another device, another group of systems, or another group of devices, separate from or including ML bias management system 202, such as ML model management system 102, database 104, user device 106, agent device 108, and/or the like.

As shown in FIG. 3, at step 302, process 300 may include retrieving a parameter from model requirement data. For example, ML bias management system 202 may retrieve at least one parameter from the model requirement data (e.g., model requirement data stored in database 104) based on a specified location.

As shown in FIG. 3, at step 304, process 300 may include executing a machine learning model. For example, ML bias management system 202 may execute at least one machine learning model based on input data to generate an output. In some non-limiting embodiments or aspects, the input data may be based at least partially on the at least one parameter. In some non-limiting embodiments or aspects, software agent 204 may be configured to retrieve the at least one parameter and/or execute the at least one machine learning model.

As shown in FIG. 3, at step 306, process 300 may include generating a bias metric. For example, ML bias management system 202 may generate a bias metric based on the output and the at least one parameter.

As shown in FIG. 3, at step 308, process 300 may include executing a mitigation procedure. For example, ML bias management system 202 may determine a mitigation procedure based on the bias metric and execute the mitigation procedure.

In some non-limiting embodiments or aspects, ML bias management system 202 may automatically re-execute the at least one machine-learning model and/or automatically execute an updated mitigation procedure based on updates to the model requirement data.

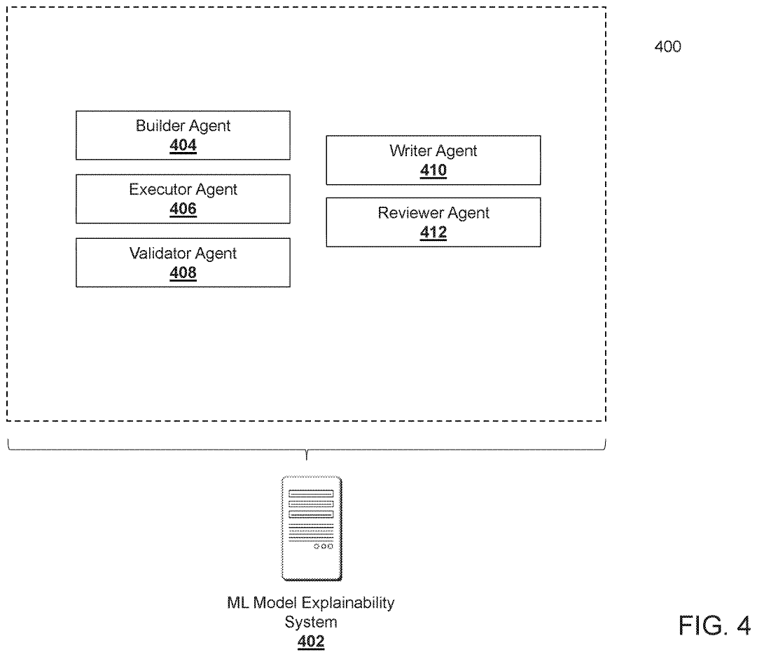

Referring now to FIG. 4, shown is a schematic diagram of exemplary system architecture 400 of ML model explainability system 402 for providing model explainability information regarding a machine learning model, according to some non-limiting embodiments or aspects. In some non-limiting embodiments or aspects, one or more components of system architecture 400 may be included in ML model explainability system 402. In some non-limiting embodiments or aspects, one or more of the components of system architecture 400 may be (e.g., completely, partially, etc.) a component of another device or a group of devices separate from or including ML model explainability system 402, such as ML model management system 102, database 104, and/or user device 106. In some non-limiting embodiments or aspects, ML model explainability system 402 may be the same as or similar to ML model management system 102.

As shown in FIG. 4, system architecture 400 of ML model explainability system 402 may include builder agent 404, executor agent 406, validator agent 408, writer agent 410, and reviewer agent 412. In some non-limiting embodiments or aspects, builder agent 404, executor agent 406, validator agent 408, writer agent 410, and/or reviewer agent 412 may be the same as or similar to software agent 110.

In some non-limiting embodiments or aspects, builder agent 404 may have a role as a Python coding expert and may write Python code (e.g., Python notebook code) to perform an explainability test for a given machine learning model and data location. The Python code may offer local and/or global explainability. In some non-limiting embodiments or aspects, builder agent 404 may use an explainer (e.g., an optimized explainer) if an algorithm is not specified.

In some non-limiting embodiments or aspects, executor agent 406 may have a role as an AI expert and may use the generated code from builder agent 404 to perform a model explainability test. In some non-limiting embodiments or aspects, executor agent 406 may generate an output specified in requirements (e.g., user requirements that may include model location, data location, explainability type (local/global), explainer method, and/or report content requirements). In some non-limiting embodiments or aspects, executor agent 406 may choose random data points for local explanations (e.g., if there are no constraints).

In some non-limiting embodiments or aspects, validator agent 408 may have a role as a data analyst and may analyze the output provided (e.g., provided by executor agent 406), validate that all outputs meet the requirements, and/or provide detailed insights and analysis.

In some non-limiting embodiments or aspects, writer agent 410 may have a role as a technical report writer and may generate a report (e.g., a review report, a final report, etc.) using the data specified in the requirements. In some non-limiting embodiments or aspects, writer agent 410 may check a RAG procedure first for recommendations and, if insufficient, writer agent 410 may use a search tool. In some non-limiting embodiments or aspects, a report may include model information, algorithm, test results, insight, and/or a recommended action.

In some non-limiting embodiments or aspects, reviewer agent 412 may have a role as a technical report review expert and may review a report to ensure the report does not contain incorrect information. In some non-limiting embodiments or aspects, reviewer agent 412 may use both RAG and a search tool for validation and may generate a report based on the results of validation.

In some non-limiting embodiments or aspects, ML model explainability system 402 may implement two models relating to explainability: local explainability (e.g., individual prediction explanations) and/or global explainability (e.g., overall machine learning model behavior analysis). In some non-limiting embodiments or aspects, ML model explainability system 402 may implement local explainability to explain individual predictions by analyzing one or more specific data points, for example, unusual and/or edge cases, to provide an explanation why the model generated a particular prediction. In some non-limiting embodiments or aspects, ML model explainability system 402 may receive a specific number of cases to be examined (e.g., 3 unusual cases in the local explanation) or ML model explainability system 402 may choose random data points, if no constraints are specified. In some non-limiting embodiments or aspects, ML model explainability system 402 may implement global explainability to assess overall model behavior by evaluating a model's behavior across a full dataset, including feature importance rankings that may explain which features most influence a model's predictions overall.

In some non-limiting embodiments or aspects, ML model explainability system 402 may support explainability methods using Shapley Additive Explanations (SHAP). In some non-limiting embodiments or aspects, ML model explainability system 402 may receive a specification (e.g., requirements) from a user to utilize a particular explainer, such as SHAP. In some non-limiting embodiments or aspects, ML model explainability system 402 may not receive any specification as to the algorithm to be used. In such situations, ML model explainability system 402 (e.g., builder agent 404 of ML model explainability system 402) may then select an explainer automatically based on model data and/or characteristics.

In some non-limiting embodiments or aspects, builder agent 404 may analyze requirements by generating executable code for explainability tests by parsing a user's requirements, including model location, data location, explainability type (e.g., local and/or global), explainer method, and/or report content requirements. In some non-limiting embodiments or aspects, builder agent 404 may create code by generating Python code (e.g., Python notebook code) to perform an explainability test for a given model and data location. The code may offer both local and global explainability. In some non-limiting embodiments or aspects, builder agent 404 may self-validate generated code for correctness.

In some non-limiting embodiments or aspects, ML model explainability system 402 may receive instructions for modeling, including model and data location, a request to test both local and global explainability, a number of cases to examine, whether SHAP should be used, and/or an instruction as to an output, for example, a final report that includes feature importance. In some non-limiting embodiments or aspects, executor agent 406 of ML model explainability system 402 may run generated code against a target model. In some non-limiting embodiments or aspects, executor agent 406 may analyze requirements by determining an expected output format based on requirements. In some non-limiting embodiments or aspects, executor agent 406 may load a model and data by locating and loading target model data and associated data. In some non-limiting embodiments or aspects, executor agent 406 may generate an alert if a target model and/or associated data cannot be found. In some non-limiting embodiments or aspects, executor agent 406 may run explainability code by generating executed code against a model. The output of such execution may include local and/or global explainability results, based on a specification (e.g., user requirements).

In some non-limiting embodiments or aspects, of ML model explainability system 402 may validate that an output from the executor agent 406 meets specified requirements. In some non-limiting embodiments or aspects, validator agent 408 may check output against requirement(s) by verifying that one or more (e.g., all) outputs from executor agent 406 (e.g., local explanations, global explanations, and/or feature importance) are present and complete. In some non-limiting embodiments or aspects, validator agent 408 may check incorrect output by identifying any incorrect and/or inconsistent results and may handle issues by requesting re-tests from executor agent 406, for example, if one or more issues are identified in the output.

In some non-limiting embodiments or aspects, writer agent 410 of ML model explainability system 402 may generate a final explainability report. In some non-limiting embodiments or aspects, writer agent 410 may analyze requirements by determining report content requirements, and may analyze test results and a report of validator agent 408 by processing test results and validation reports. In some non-limiting embodiments or aspects, writer agent 410 may identify one or more recommendations, for example, by checking RAG for relevant data and, if RAG is insufficient, utilizing a search tool. In some non-limiting embodiments or aspects, writer agent 410 may generate (e.g., write) a report by generating a final report and saving results. In some non-limiting embodiments or aspects, a report may include one or more of a test result section (e.g., local and global explainability results, which may include graphical output, such as charts and/or verbal and/or written explanations), an insight section (e.g., detailed analysis and insights based at least in part on explainability results), and/or a recommended action section (e.g., actionable recommendations based at least in part on analysis as described above).

In some non-limiting embodiments or aspects, reviewer agent 412 of ML model explainability system 402 may provide critical analysis of generated report(s), thereby providing increased quality and/or correctness. In some non-limiting embodiments or aspects, reviewer agent 412 may analyze requirements by determining what a report is to contain based on specified requirements. In some non-limiting embodiments or aspects, reviewer agent 412 may check generated reports by reviewing final reports using RAG and/or search tools for validation. In some non-limiting embodiments or aspects, reviewer agent 412 may check requirements by verifying that reports meet specified requirements. In some non-limiting embodiments or aspects, reviewer agent 412 may handle issues by, for example, if a report does not meet one or more requirements, checking for incorrect data. In some non-limiting embodiments or aspects, reviewer agent 412 may handle issues by, for example, if no issues are identified, generating a review summary and requesting a re-write from reviewer agent 412. In some non-limiting embodiments or aspects, reviewer agent 412 may handle issues by, for example, if no issues are identified, saving a review result and generating an alert. In some non-limiting embodiments or aspects, reviewer agent 412 may specifically verify that reports do not contain incorrect and/or unnecessary data, for example, due to a hallucination.

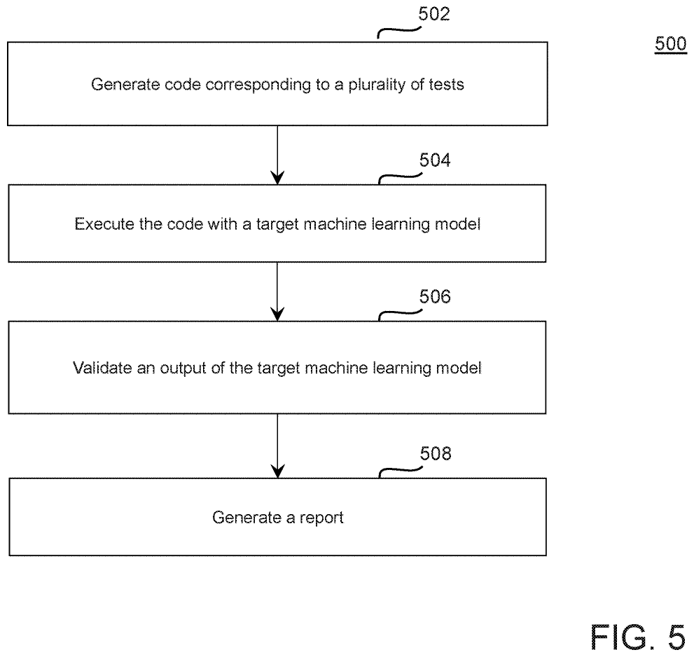

Referring now to FIG. 5, shown is a flow diagram for process 500 for providing model explainability information regarding a machine learning model, according to some non-limiting embodiments or aspects. The steps shown in FIG. 5 are for example purposes only. It will be appreciated that additional, fewer, different, and/or different order of steps may be used in non-limiting embodiments or aspects. In some non-limiting embodiments or aspects, a step may be automatically performed in response to performance and/or completion of a prior step. In some non-limiting embodiments or aspects, one or more of the steps of process 500 may be performed (e.g., completely, partially, and/or the like) by ML model explainability system 402 (e.g., at least one component of ML model explainability system 402, as shown in FIG. 5). In some non-limiting embodiments or aspects, one or more of the steps of process 500 may be performed (e.g., completely, partially, and/or the like) by another system, another device, another group of systems, or another group of devices, separate from or including ML model explainability system 402, such as ML model management system 102, database 104, user device 106, agent device 108, and/or the like.

As shown in FIG. 5, at step 502, process 500 may include generating code corresponding to a plurality of tests. For example, ML model explainability system 402 may generate, with a software agent (e.g., a first software agent), code corresponding to a plurality of tests.

As shown in FIG. 5, at step 504, process 500 may include executing the code with a target machine learning model. For example, ML model explainability system 402 may execute, with a software agent (e.g., a second software agent), the code with a target model to generate an output. In some non-limiting embodiments or aspects, the output may include at least one local output and at least one global output.

As shown in FIG. 5, at step 506, process 500 may include validating an output of the target machine learning model. For example, ML model explainability system 402 may validate, with a software agent (e.g., a third software agent), at least one local output and/or at least one global output.

As shown in FIG. 5, at step 508, process 500 may include generating a report. For example, ML model explainability system 402 may generate a report based on the output of the target machine learning model. In some non-limiting embodiments or aspects, ML model explainability system 402 may generate, with a software agent (e.g., a fourth software agent), a report based on the at least one local output and the at least one global output. In some non-limiting embodiments or aspects, the report may include at least one recommendation. For example, the report may include at least one recommendation based on retrieving at least one data element and inputting the at least one element and the report into a generative AI model.

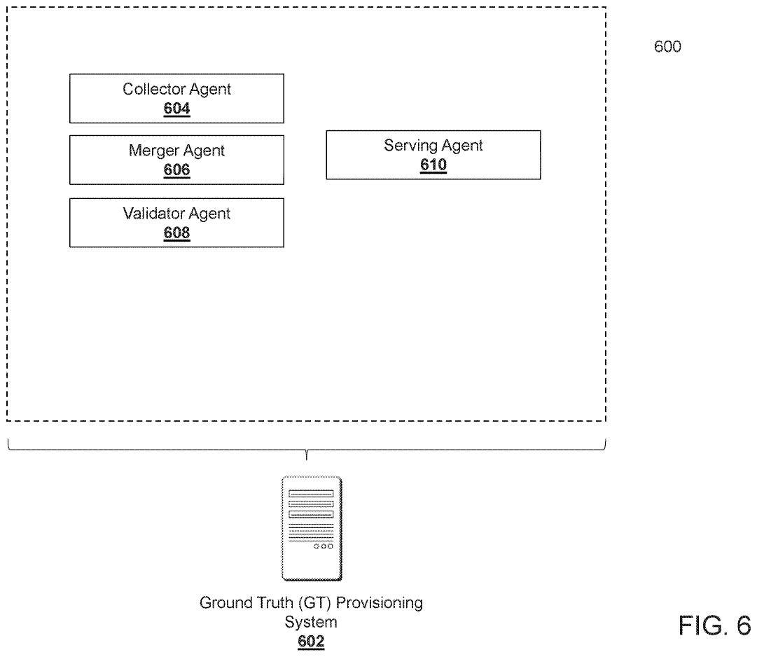

Referring now to FIG. 6, shown is a schematic diagram of exemplary system architecture 600 of ground truth (GT) provisioning system 602 for providing a ground truth framework for a plurality of machine learning models, according to some non-limiting embodiments or aspects. In some non-limiting embodiments or aspects, one or more components of system architecture 600 may be included in GT provisioning system 602. In some non-limiting embodiments or aspects, one or more of the components of system architecture 600 may be (e.g., completely, partially, etc.) a component of another device or a group of devices separate from or including GT provisioning system 602, such as ML model management system 102, database 104, and/or user device 106. In some non-limiting embodiments or aspects, GT provisioning system 602 may be the same as or similar to ML model management system 102.

As shown in FIG. 6, system architecture 600 of GT provisioning system 602 may include collector agent 604, merger agent 606, validator agent 608, and serving agent 610. In some non-limiting embodiments or aspects, collector agent 604, merger agent 606, validator agent 608, and serving agent 610 may be the same as or similar to software agent 110.

In some non-limiting embodiments or aspects, collector agent 604 may have a role as a big data expert and may find ground truth information in tables (e.g., in data tables, such as data tables in data sources for ground truth storage, such as transaction code 40 (TC40) fraud data, data catalog services, and databases in a cloud, such as Google cloud platform). In some non-limiting embodiments or aspects, collector agent 604 may return table names and/or schemas. In some non-limiting embodiments or aspects, collector agent 604 may prioritize results, if multiple tables are found.

In some non-limiting embodiments or aspects, merger agent 606 may have a role as a big data expert and may merge a transaction table and a ground truth table to provide a merged table using transaction ID matching, date/merchant ID matching, and/or a similarity search. In some non-limiting embodiments or aspects, merger agent 606 may provide a merged table name and schema.

In some non-limiting embodiments or aspects, validator agent 608 may have a role as a data analyst and may evaluate the merged table schema and merged table data. In some non-limiting embodiments or aspects, validator agent 608 may calculate a matching rate and/or generate a validation report.

In some non-limiting embodiments or aspects, serving agent 610 may have a role as a software engineer and may load the merged table, update the ground truth catalog, create an API endpoint, and/or update and deploy an SDK.

In some non-limiting embodiments, GT provisioning system 602 may include a ground truth repository, which may be structured around a ground truth framework catalog. The ground truth framework catalog may serve as a central registry for all ground truth datasets and may be maintained through data sources. In some non-limiting embodiments, ground truth information may be collected from multiple sources, including a ground truth store (e.g., transaction code 40 (TC40) fraud data, data catalog services, and/or large data databases, such as cloud platforms), catalog updates, and/or access. In some non-limiting embodiments, serving agent 610 may automatically update the ground truth framework catalog whenever new merged and/or validated ground truth data is generated. In some non-limiting embodiments, GT provisioning system 602 may allow for retrieval of ground truth data for a given machine learning model using, for example, natural language queries. In some non-limiting embodiments, a ground truth platform, as provided with regard to GT provisioning system 602, may interact with other systems described herein, such as ML bias management system 202, ML model explainability system 402, ML model monitoring system 802, and/or ML model discovery system 1002.

In some non-limiting embodiments, collector agent 604 of GT provisioning system 602 may search for ground truth tables across one or more available data sources and may prioritize results (e.g., search results). In some non-limiting embodiments, collector agent 604 may analyze requirements by parsing a request (e.g., a user request) for a model name, transaction data location, and/or ground truth needs. In some non-limiting embodiments, collector agent 604 may search one or more ground truth stores, one or more data catalogs, and/or one or more cloud-based databases (e.g., big data cloud platforms). In some non-limiting embodiments, collector agent 604 may identify a plurality of tables and may utilize an LLM to prioritize results and present (e.g., display) the results with, for example, a table name, schema, and/or location.

In some non-limiting embodiments, merger agent 606 of GT provisioning system 602 may automatically merge a transaction table and a ground truth table, for example, using a cascading set of methods applied in a particular order. Such a particular order may include: transaction ID matching (e.g., joining records by matching transaction identifiers directly, where, if all records are matched, a merge is considered complete); transaction date and merchant ID matching (e.g., for unmatched records, GT provisioning system 602 may attempt to join by combining transaction date and merchant ID fields where, if all remaining records are matched, a merge is considered complete); and/or similarity search (e.g., for any records that cannot be matched with transaction ID matching and/or transaction date and merchant ID matching, GT provisioning system 602 may apply a similarity search to merge any remaining records). In some non-limiting embodiments, after applying one or more of the foregoing methods, merger agent 606 may join both tables, provide a merged table name and/or schema, save the merged table, and/or create a merge report.

In some non-limiting embodiments, validator agent 608 of GT provisioning system 602 may verify a merged table generated by merger agent 606 and may generate a validation report. An exemplary validation process may include: loading a report (e.g., processing a merge report from merger agent 606); calculating a matching rate (e.g., evaluating a merged table's schema and/or data and compute a matching rate considering methods used during merging, such as transaction ID matching, transaction date and merchant ID matching, and/or similarity search); and/or generating a validation report (e.g., a validation report that may include matching results, matching rate per merged method, and/or an assessment of data quality and schema correctness).

In some non-limiting embodiments, serving agent 610 of GT provisioning system 602 may automate delivery of validated ground truth data. An exemplary automated delivery process may include: loading a merged table (e.g., processing a validated, merged table); updating a ground truth catalog (e.g., registering a new dataset in the ground truth framework catalog); creating an endpoint for an API (e.g., automatically generating an API endpoint for a new ground truth dataset); and/or updating SDK (e.g., updating SDK code to include access to a new dataset and, optionally, deploy the new dataset). In some non-limiting embodiments, serving agent 610 may allow other systems described herein, such as ML bias management system 202, ML model explainability system 402, ML model monitoring system 802, and/or ML model discovery system 1002, to programmatically access ground truth data via API or SDK.

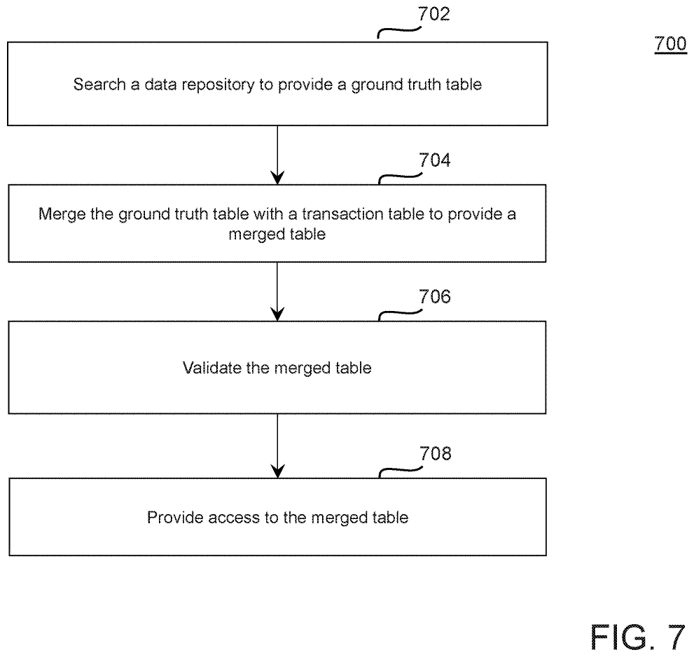

Referring now to FIG. 7, shown is a flow diagram for process 700 for providing a ground truth framework for a plurality of machine learning models, according to some non-limiting embodiments or aspects. The steps shown in FIG. 7 are for example purposes only. It will be appreciated that additional, fewer, different, and/or different order of steps may be used in non-limiting embodiments or aspects. In some non-limiting embodiments or aspects, a step may be automatically performed in response to performance and/or completion of a prior step. In some non-limiting embodiments or aspects, one or more of the steps of process 700 may be performed (e.g., completely, partially, and/or the like) by GT provisioning system 602 (e.g., at least one component of GT provisioning system 602, as shown in FIG. 6). In some non-limiting embodiments or aspects, one or more of the steps of process 700 may be performed (e.g., completely, partially, and/or the like) by another system, another device, another group of systems, or another group of devices, separate from or including GT provisioning system 602, such as ML model management system 102, database 104, user device 106, agent device 108, and/or the like.

As shown in FIG. 7, at step 702, process 700 may include searching a data repository to provide a ground truth table. For example, GT provisioning system 602 may search a ground truth repository (e.g., a ground truth repository stored in database 104) based on model data (e.g., provided by a user) for a machine-learning model, resulting in a ground truth table. In some non-limiting embodiments or aspects, GT provisioning system 602 may search, with a software agent (e.g., a first software agent), the ground truth repository to provide the ground truth table.

As shown in FIG. 7, at step 704, process 700 may include merging the ground truth table with a transaction table to provide a merged table. For example, GT provisioning system 602 may merge the ground truth table with a transaction table representing transaction data (e.g., corresponding to at least one merchant, resulting in a merged table). In some non-limiting embodiments or aspects, GT provisioning system 602 may merge, with a software agent (e.g., a second software agent), the ground truth table with the transaction table to provide the merged table.

As shown in FIG. 7, at step 706, process 700 may include validating the merged table. For example, GT provisioning system 602 may validate, with a software agent (e.g., a third software agent), the merged table.

As shown in FIG. 7, at step 708, process 700 may include providing access to the merged table. For example, GT provisioning system 602 may provide access to the merged table via at least one interface (e.g., a graphical user interface (GUI)).

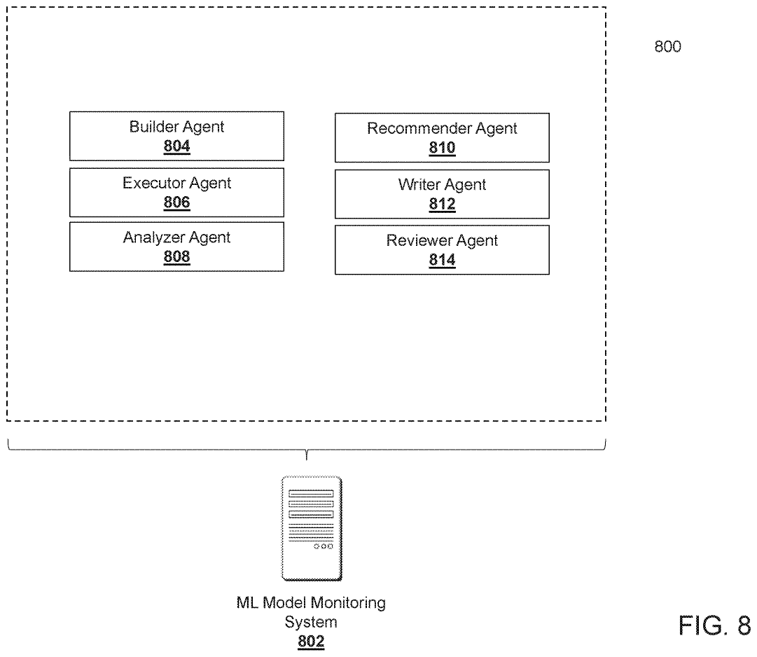

Referring now to FIG. 8, shown is a schematic diagram of exemplary system architecture 800 of ML model monitoring system 802 for drift monitoring of machine learning models, according to some non-limiting embodiments or aspects. In some non-limiting embodiments or aspects, one or more components of system architecture 800 may be included in ML model monitoring system 802. In some non-limiting embodiments or aspects, one or more of the components of system architecture 800 may be (e.g., completely, partially, etc.) a component of another device or a group of devices separate from or including ML model monitoring system 802, such as ML model management system 102, database 104, and/or user device 106. In some non-limiting embodiments or aspects, ML model monitoring system 802 may be the same as or similar to ML model management system 102.

As shown in FIG. 8, system architecture 800 of ML model monitoring system 802 may include builder agent 804, executor agent 806, analyzer agent 808, recommender agent 810, writer agent 812, and reviewer agent 814. In some non-limiting embodiments or aspects, builder agent 804, executor agent 806, analyzer agent 808, recommender agent 810, writer agent 812, and reviewer agent 814 may be the same as or similar to software agent 110.

In some non-limiting embodiments or aspects, builder agent 804 may have a role as a Python coding expert and may write Python code (e.g., Python notebook code) to perform drift detection for a machine learning model and data location. In some non-limiting embodiments or aspects, builder agent 804 may write code based on a user's requirements.

In some non-limiting embodiments or aspects, executor agent 806 may have a role as an AI expert and may use the code generated from builder agent 804 to detect drift (e.g., model drift and/or data drift) and/or calculate the drift for the data and machine learning model. In some non-limiting embodiments or aspects, executor agent 806 may store all outputs in a specified location.

In some non-limiting embodiments or aspects, analyzer agent 808 may have a role as a data analyst and may analyze the drift detection result considering user requirements. In some non-limiting embodiments or aspects, analyzer agent 808 may provide metrics and/or drift score and compare the metrics and/or drift score with historical drift calculation results.

In some non-limiting embodiments or aspects, recommender agent 810 may have a role as a recommendation expert and may recommend an appropriate action a user can take based on the data from analyzer agent 808. In some non-limiting embodiments or aspects, recommender agent 810 may RAG and/or search tools to determine market trends and/or economic situations.

In some non-limiting embodiments or aspects, writer agent 812 may have a role as a technical report writer and may generate a report using data provided per requirements. In some non-limiting embodiments or aspects, the report may include detected drift information, metrics, comparison, impact, and/or a recommendation. In some non-limiting embodiments or aspects, writer agent 812 may use RAG and/or search tools for recommended actions.

In some non-limiting embodiments or aspects, reviewer agent 814 may have a role as a technical report review expert and may review a report to ensure the report does not contain incorrect information. In some non-limiting embodiments or aspects, reviewer agent 814 may use both RAG and a search tool for validation. In some non-limiting embodiments or aspects, reviewer agent 814 may generate a report (e.g., a review report, a final report, etc.).

In some non-limiting embodiments or aspects, ML model monitoring system 802 may measure model drift by determining a configuration. In some non-limiting embodiments or aspects, a user may specify requirements, such as drift monitoring parameters, that may include at least one of the following: type (e.g., model drift), data location, metrics to monitor (e.g., accuracy drift, F1 score drift, etc.), monitoring interval (e.g., daily, weekly, bi-weekly, etc.), duration of monitoring (e.g., a time interval, such as weeks, months, years, such as 3 years), alert level threshold (e.g., threshold that identifies when a machine learning model is under 90%), a notification destination (e.g., contact information, such as an email address), or any combination thereof. ML model monitoring system 802 may determine a configuration for monitoring based on drift monitoring parameters received from a user. In some non-limiting embodiments or aspects, ML model monitoring system 802 may further measure model drift by creating Python code with builder agent 804 for drift detection and/or metrics calculation based on the requirements. In some non-limiting embodiments or aspects, ML model monitoring system 802 may further measure model drift by detecting drift where executor agent 806 runs the generated drift detection code against target data and/or reference data to detect drifts and/or calculate the specified metrics.

In some non-limiting embodiments or aspects, ML model monitoring system 802 may further measure model drift by analyzing the drift detection result with analyzer agent 808. In some non-limiting embodiments or aspects, analyzer agent 808 may compare the current metrics with historical drift calculation results, load and/or maintain previous analysis data for historical comparison, assign an overall drift score, and provide metrics as specified in the requirements.

In some non-limiting embodiments or aspects, ML model monitoring system 802 may also find optimal metrics on behalf of users when domain knowledge is lacking using a software agent.

In some non-limiting embodiments or aspects, ML model monitoring system 802 may monitor data drift alongside model drift using the same agent pipeline. In some non-limiting embodiments or aspects, executor agent 806 detects drifts and calculates metrics with target data and/or reference data. Analyzer agent 808 may compare current results against historical data, assign drift scores, and/or identify distribution shifts across the monitored data attributes.

In some non-limiting embodiments or aspects, with regard to seasonal events and economic events, recommender agent 810 may account for external factors when generating recommended actions. In some non-limiting embodiments or aspects, recommender agent 810 may use RAG and search tools to determine market trends and/or economic situations relevant to the detected drift.

In some non-limiting embodiments or aspects, ML model monitoring system 802 may consider seasonal events and economic events when analyzing whether detected drift is expected (e.g., seasonal patterns) or is indicative of a genuine issue requiring action. This context-aware analysis may prevent false alarms from predictable seasonal fluctuations and may ensure that recommendations are appropriate for the current economic environment.

In some non-limiting embodiments or aspects, with regard to recommended actions for drift scenarios, when drift is detected, recommender agent 810 may generate context-aware recommended actions. In some non-limiting embodiments or aspects, the context-aware recommended actions may be determined by loading results from analyzer agent 808 to ingest the drift detection results, drift scores, and/or historical comparisons; determining whether drift exists based on the analysis; if drift exists, using RAG and search tools to determine the appropriate action considering market trends and economic situations. In some non-limiting embodiments or aspects, recommender agent 810 may provide recommended actions, which may include triggering model retraining and/or model redeployment. In some non-limiting embodiments or aspects, reviewer agent 814 may also trigger retraining and/or redeployment as part of a recommended response to drift.

In some non-limiting embodiments or aspects, writer agent 812 generates a final report containing both charts and verbal explanations. The report may include the following sections: detected drift Information, which may include a description of the drift detected, type, and/or affected metrics; metrics, which may include calculated drift scores and performance metrics; comparison, which may include a historical comparison of current metrics against prior drift calculation results; impact, which may include an assessment of the impact of drift on model performance; and recommendation, which may include recommended actions considering seasonal events and/or economic events. In some non-limiting embodiments or aspects, reviewer agent 814 may validate the report using RAG and/or search tools by verifying that the report does not contain incorrect or unnecessary information due to hallucination. If issues are found, reviewer agent 814 may create a review summary and/or request a re-write from writer agent 812.

In some non-limiting embodiments or aspects, with regard to scheduling and notification, a configuration manager of ML model monitoring system 802 may schedule drift monitoring jobs based on a configuration provided by a user. In some non-limiting embodiments or aspects, ML model monitoring system 802 may run jobs at the specified interval for a specified duration. In some non-limiting embodiments or aspects, when drift metrics fall below the alert level threshold (e.g., under 90%), ML model monitoring system 802 may trigger notification to a user via the specified communication channel (e.g., email, text, etc.). In some non-limiting embodiments or aspects, ML model monitoring system 802 may send a final report to a user upon completion of each monitoring cycle.

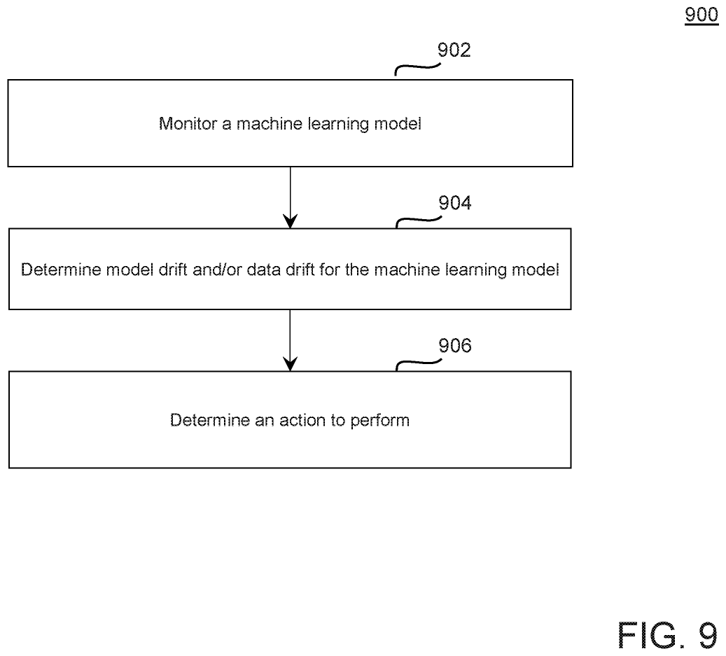

Referring now to FIG. 9, shown is a flow diagram for process 900 for drift monitoring of machine learning models, according to some non-limiting embodiments or aspects. The steps shown in FIG. 9 are for example purposes only. It will be appreciated that additional, fewer, different, and/or different order of steps may be used in non-limiting embodiments or aspects. In some non-limiting embodiments or aspects, a step may be automatically performed in response to performance and/or completion of a prior step. In some non-limiting embodiments or aspects, one or more of the steps of process 900 may be performed (e.g., completely, partially, and/or the like) by ML model monitoring system 802 (e.g., at least one component of ML model monitoring system 802, as shown in FIG. 8). In some non-limiting embodiments or aspects, one or more of the steps of process 900 may be performed (e.g., completely, partially, and/or the like) by another system, another device, another group of systems, or another group of devices, separate from or including ML model monitoring system 802, such as ML model management system 102, database 104, user device 106, agent device 108, and/or the like.

As shown in FIG. 9, at step 902, process 900 may include monitoring a machine learning model. For example, ML model monitoring system 802 may monitor one or more machine learning models (e.g., a plurality of machine learning models, a single machine learning model, each machine learning model of a plurality of machine learning models etc.) associated with an entity by recording input and output data for the one or more machine learning models over a plurality of executions of the one or more machine learning models. In some non-limiting embodiments or aspects, ML model monitoring system 802 may monitor, with a software agent (e.g., a first software agent), the one or more machine learning models by recording input and output data for the one or more machine learning models.

As shown in FIG. 9, at step 904, process 900 may include determining model drift and/or data drift for the machine learning model. For example, ML model monitoring system 802 may determine model drift and/or data drift for the one or more machine learning models. In some non-limiting embodiments or aspects, ML model monitoring system 802 may determine, with a software agent (e.g., a second software agent) model drift and/or data drift for the one or more machine learning models.

As shown in FIG. 9, at step 906, process 900 may include determining an action to perform. For example, ML model monitoring system 802 may determine a recommended action to perform on the one or more machine learning models based on an event, such as a seasonal event and/or economic event. In some non-limiting embodiments or aspects, ML model monitoring system 802 may determine, with a software agent (e.g., a third software agent), a recommended action to perform on the one or more machine learning models based on the event. In some non-limiting embodiments or aspects, ML model monitoring system 802 may determine the recommended action to perform on the one or more machine learning models based on the event and model drift and/or data drift for the one or more machine learning models.

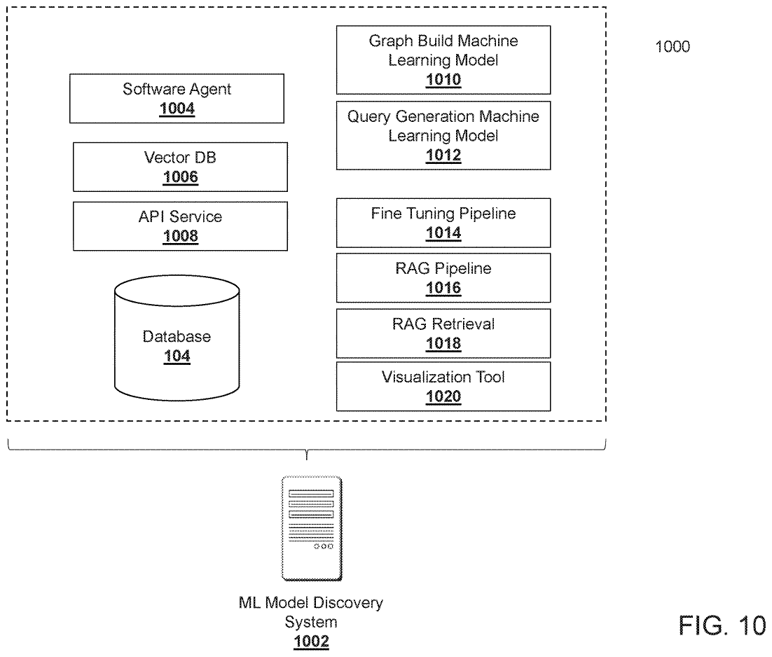

Referring now to FIG. 10, shown is a schematic diagram of exemplary system architecture 1000 of ML model discovery system 1002 for providing complex information regarding a plurality of machine learning models, according to some non-limiting embodiments or aspects. In some non-limiting embodiments or aspects, one or more components of system architecture 1000 may be included in ML model discovery system 1002. In some non-limiting embodiments or aspects, one or more of the components of system architecture 1000 may be (e.g., completely, partially, etc.) a component of another device or a group of devices separate from or including ML model discovery system 1002, such as ML model management system 102, database 104, and/or user device 106. In some non-limiting embodiments or aspects, ML model discovery system 1002 may be the same as or similar to ML model management system 102.

As shown in FIG. 10, system architecture 1000 of ML model discovery system 1002 may include software agent 1004, vector database (DB) 1006, API service 1008, graph build machine learning model 1010, query generation machine learning model 1012, fine tuning pipeline 1014, RAG pipeline 1016, RAG retrieval 1018, visualization tool 1020, and database 104.

In some non-limiting embodiments or aspects, database 104 may store and/or organize diverse model-related data including metadata, performance metrics, data drift metrics, fairness reports, and/or risk analysis reports. In some non-limiting embodiments or aspects, software agent 1004 may orchestrate an entire data retrieval and analysis process. In some non-limiting embodiments or aspects, software agent 1004 may break down complex queries into manageable parts using RAG. In some non-limiting embodiments or aspects, vector DB 1006 may be optimized for storing and/or retrieving high-dimensional vectors to support efficient similarity searches.

In some non-limiting embodiments or aspects, API service 1008 may provide an interface for users to send queries to software agent 1004. In some non-limiting embodiments or aspects, graph build machine learning model 1010 may include an LLM that groups results based on similarity (e.g., based on demographics, regions, algorithm types, etc.) and maps relationships among grouped models. In some non-limiting embodiments or aspects, query generation machine learning model 1012 may include an LLM that processes and understands natural language and breaks down questions into queries that software agent 1004 can use. In some non-limiting embodiments or aspects, fine tuning pipeline 1014 may fine-tune the LLM of query generation machine learning model 1012 to generate queries in a specific output format. In some non-limiting embodiments or aspects, RAG pipeline 1016 may read data from database 104, convert the data to high-dimensional vectors, and store the high-dimensional vectors in vector DB 1006. In some non-limiting embodiments or aspects, RAG retrieval 1018 may retrieve relevant information using advanced similarity search methods, such as BERT-based semantic search. In some non-limiting embodiments or aspects, visualization tool 1020 may include a user interface (e.g., a GUI) that presents grouped and/or analyzed outputs in an interactive manner.

In some non-limiting embodiments or aspects, ML model discovery system 1002 may use query generation machine learning model 1012 (e.g., which has been fined tuned via fine tuning pipeline 1014) to decompose complex natural language queries into structured, manageable sub-tasks. In some non-limiting embodiments or aspects, ML model discovery system 1002 may include query generation machine learning model 1012 as a fine-tuned LLM model that is integrated into software agent 1004. Query generation machine learning model 1012 may be trained on a dataset of user queries paired with structured JSON task/parameter outputs, enabling query generation machine learning model 1012 to convert natural language into actionable query components.

In some non-limiting embodiments or aspects, when a user submits a complex query, query generation machine learning model 1012 parses the query into a structured JSON format containing a task identifier (e.g., find models, locate models, identify models, discover models, etc.) and/or parameters extracted from the query (e.g., model type, deployment region, fairness score thresholds, time periods, grouping criteria, etc.). In some non-limiting embodiments or aspects, software agent 1004 may execute the decomposed query in sequential steps by parsing the JSON query to extract the task and parameters, retrieving model information by querying vector DB 1006 using primary filters (e.g., model type, deployment region, etc.), applying secondary filters by filtering retrieved results by additional criteria (e.g., fairness score threshold), categorizing (e.g., grouping) results by categorizing the filtered results by specified dimensions (e.g., risk levels per regulation). In some non-limiting embodiments or aspects, software agent 1004 may compile results by producing a structured list of models with relevant details.

In one example: For a query of *“Find authentication models deployed in the EU with a high fairness score and categorize the results by risk levels as defined by the EU AI Act”*, query generation machine learning model 1012 may generate appropriate code to carry out the query. Software agent 1004 may then execute the code to retrieve authentication models in the EU from the vector DB, filter by high fairness score, categorize by EU AI Act risk levels, and compile results.

In some non-limiting embodiments or aspects, ML model discovery system 1002 may use advanced similarity search methods for information retrieval. For example, RAG pipeline 1016 may read data from database 104 (e.g., an AI observatory), convert the data to high-dimensional vectors (e.g., vector embeddings), and store the results in vector DB 1006. In some non-limiting embodiments or aspects, data sources may include model metadata, drift metrics and/or performance metrics, compliance reports, and/or model security reports, and/or model safety reports. In some non-limiting embodiments or aspects, RAG retrieval 1018 may retrieve relevant information using advanced similarity search methods including cosine similarity and/or BERT-based semantic search. In some non-limiting embodiments or aspects, software agent 1004 may utilize these similarity search methods in an iterative process to locate relevant information across a repository, ensuring comprehensive and high-quality query resolution.

In some non-limiting embodiments or aspects, after gathering information, software agent 1004 may group results based on similarity. In some non-limiting embodiments or aspects, software agent 1004 may group results using graph build machine learning model 1010. In some non-limiting embodiments or aspects, graph build machine learning model 1010 may perform grouping so that there is grouping by similarity. For example, machine learning models may be grouped by demographics, regions, algorithm types, and/or other criteria as specified in a user query (e.g., group by model owner, deployment region, fairness score, risk level). In some non-limiting embodiments or aspects, the grouped results may be saved to database 104 and made available to visualization tool 1020.

In some non-limiting embodiments or aspects, graph build machine learning model 1010 may map relationships between model groups by constructing a relationship graph. A structure of the relationship graph may include a plurality of nodes. In some non-limiting embodiments or aspects, each unique item in the data becomes a node, typed by category (e.g., model name, model owner, deployment region, fairness score, risk level, etc.). The relationship graph may further include a plurality of edges, where each model name node is connected to its corresponding attribute nodes (owner, regions, scores, risk levels, etc.), forming a relationship map. In some non-limiting embodiments or aspects, the nodes may be grouped by categories to show which models share common attributes (e.g., same owner, same deployment region, same risk level, etc.). In some non-limiting embodiments or aspects, an output of graph build machine learning model 1010 may be structured as JSON including nodes, edges, and groups, which may enable visualization tool 1020 to render the relationship graph.

In some non-limiting embodiments or aspects, ML model discovery system 1002 may present results through visualization tool 1020 as an interactive visualization tool that shows grouped models and/or relationships as a network (e.g., in a relationship graph). The interactive visualization tool may provide interactive features to help users explore and understand the data easily. ML model discovery system 1002 may allow for users to customize a visualization to focus on specific aspects, such as risk levels, performance scores, and/or geographical data.

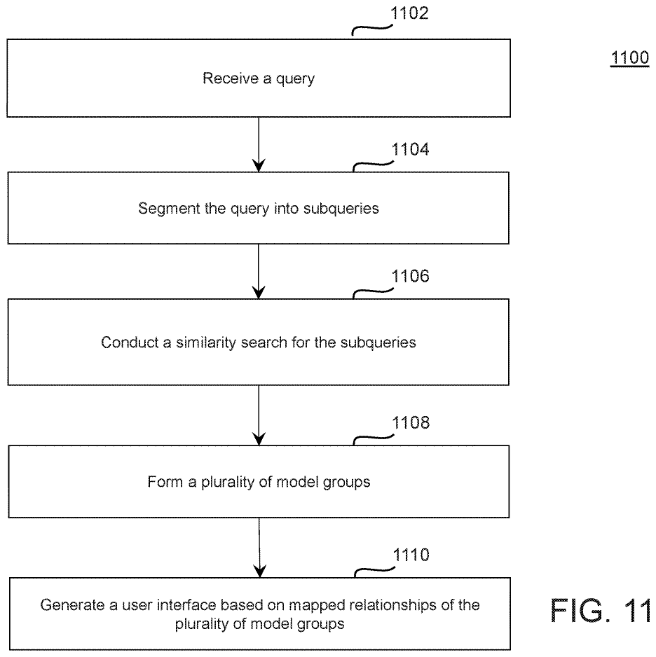

Referring now to FIG. 11, shown is a flow diagram for process 1100 for providing complex information regarding a plurality of machine learning models, according to some non-limiting embodiments or aspects. The steps shown in FIG. 11 are for example purposes only. It will be appreciated that additional, fewer, different, and/or different order of steps may be used in non-limiting embodiments or aspects. In some non-limiting embodiments or aspects, a step may be automatically performed in response to performance and/or completion of a prior step. In some non-limiting embodiments or aspects, one or more of the steps of process 1100 may be performed (e.g., completely, partially, and/or the like) by ML model discovery system 1002 (e.g., at least one component of ML model discovery system 1002, as shown in FIG. 10). In some non-limiting embodiments or aspects, one or more of the steps of process 1100 may be performed (e.g., completely, partially, and/or the like) by another system, another device, another group of systems, or another group of devices, separate from or including ML model discovery system 1002, such as ML model management system 102, database 104, user device 106, agent device 108, and/or the like.

As shown in FIG. 11, at step 1102, process 1100 may include receiving a query. For example, ML model discovery system 1002 may receive a user query (e.g., from user device 106). In some non-limiting embodiments or aspects, prior to receiving the user query, ML model discovery system 1002 may automatically retrieve model data (e.g., additional model data), where the model data may include at least one of the following: metadata, performance metrics, data drift metrics, reports, or any combination thereof. In some non-limiting embodiments or aspects, ML model discovery system 1002 may store the model data in a data storage device (e.g., database 104). In some non-limiting embodiments or aspects, ML model discovery system 1002 may retrieve model data (e.g., additional model data) from at least one external system (e.g., a system external to ML model discovery system 1002).

In some non-limiting embodiments or aspects, ML model discovery system 1002 may receive a request from a user device (e.g., user device 106) to register at least one policy. In some non-limiting embodiments or aspects, the request may identify the at least one policy and model data for at least one machine-learning model.

In some non-limiting embodiments or aspects, ML model discovery system 1002 may retrieve (e.g., with a software agent) policy data corresponding to the at least one policy (e.g., from database 104). In some non-limiting embodiments or aspects, ML model discovery system 1002 may determine a plurality of categories based on the policy data, generate a plurality of questions based on the plurality of categories, and generate answers to the plurality of questions based on the model data.

In some non-limiting embodiments or aspects, ML model discovery system 1002 may generate a GUI that is configured to display at least a portion of model data stored in a data storage device and generate at least one report based on a user interaction with the GUI and the model data.

As shown in FIG. 11, at step 1104, process 1100 may include segmenting the query into subqueries. For example, ML model discovery system 1002 may segment the user query into a plurality of subqueries.

As shown in FIG. 11, at step 1106, process 1100 may include conducting a similarity search for the subqueries. For example, ML model discovery system 1002 may conduct a similarity search for each subquery of the plurality of subqueries based on model data (e.g., model data included in the user query).

As shown in FIG. 11, at step 1108, process 1100 may include forming a plurality of model groups. For example, ML model discovery system 1002 may form a plurality of model groups based on the similarity search. In some non-limiting embodiments or aspects, ML model discovery system 1002 may map relationships between model groups of the plurality of model groups.

As shown in FIG. 11, at step 1110, process 1100 may include generating a user interface based on mapped relationships of the plurality of model groups. For example, ML model discovery system 1002 may generate a graphical user interface based on the mapped relationships between model groups of the plurality of model groups.

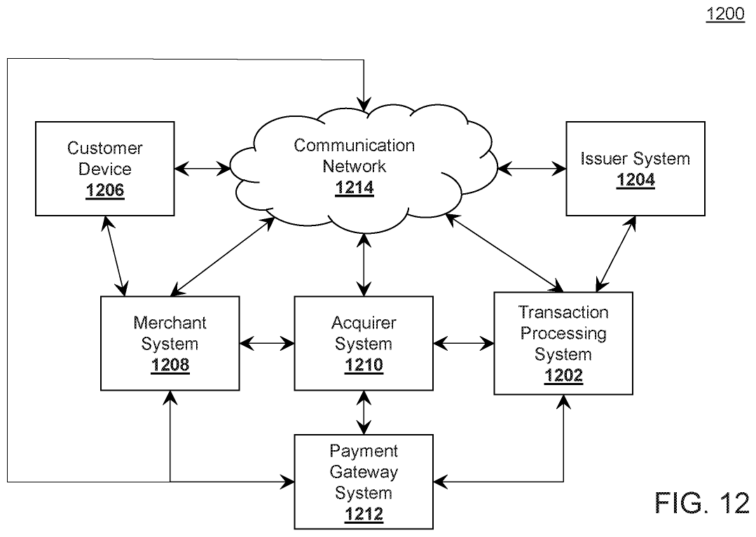

Referring now to FIG. 12, depicted is a diagram of example payment processing network 1200, according to non-limiting embodiments or aspects. In some non-limiting embodiments or aspects, payment processing network 1200 may be used in conjunction with systems, methods, and/or computer program products described herein, and/or systems methods, and/or computer program products described herein may be implemented in payment processing network 1200.

As shown in FIG. 12, payment processing network 1200 may include transaction processing system 1202, payment gateway system 1212, merchant system 1208, issuer system 1204, acquirer system 1210, and/or customer device 1206. In some non-limiting embodiments or aspects, each of ML model management system 102, database 104, and/or user device 106 of FIG. 1 may be implemented by (e.g., part of) transaction processing system 1202. In some non-limiting embodiments or aspects, at least one of ML model management system 102, database 104, user device 106, and/or agent device 108 of FIG. 1 may be implemented by (e.g., part of) another system, another device, another group of systems, or another group of devices, separate from or including transaction processing system 1202, such as merchant system 1208, issuer system 1204, acquirer system 1210, customer device 1206, and/or the like. For example, ML model management system 102 may be implemented by (e.g., part of) at least one of payment gateway system 1212, merchant system 1208, issuer system 1204, acquirer system 1210, and/or customer device 1206. The systems and/or devices of FIG. 12 may communicate via communication network 1214, which may include one or more wired and/or wireless communication networks.

Transaction processing system 1202 may include one or more devices capable of receiving information from and/or communicating information to payment gateway system 1212, merchant system 1208, issuer system 1204, acquirer system 1210, customer device 1206, and/or the like (e.g., directly, indirectly, via a public and/or private communication network connection, and/or the like). For example, as shown in FIG. 12, transaction processing system 1202 may be in communication with one or more issuer systems (e.g., issuer system 1204), one or more acquirer systems (e.g., acquirer system 1210), and/or one or more payment gateway systems (e.g., payment gateway system 1212). Although only a single issuer system 1204, a single acquirer system 1210, and a single payment gateway system 1212 are shown, it will be appreciated that transaction processing system 1202 may be in communication with a plurality of issuer systems, a plurality of acquirer systems, and/or a plurality of payment gateway systems. In some non-limiting embodiments or aspects, transaction processing system 1202 may include a computing device, such as a server (e.g., a transaction processing server), a group of servers, and/or other like devices. In some non-limiting embodiments or aspects, transaction processing system 1202 may be in communication with a data storage device, which may be local or remote to transaction processing system 1202. In some non-limiting embodiments or aspects, transaction processing system 1202 may be capable of receiving information from, storing information in, communicating information to, or searching information stored in the data storage device. In some non-limiting embodiments or aspects, transaction processing system 1202 may be associated with a transaction service provider, as described herein. In some non-limiting embodiments or aspects, transaction processing system 1202 may also operate as an issuer system, such that both transaction processing system 1202 and issuer system 1204 are a single system and/or are controlled by a single entity.

Payment gateway system 1212 may include one or more devices capable of receiving information from and/or communicating information to transaction processing system 1202, merchant system 1208, issuer system 1204, acquirer system 1210, customer device 1206, and/or the like (e.g., directly, indirectly, via a public and/or private communication network connection, and/or the like). For example, as shown in FIG. 12, payment gateway system 1212 may be in communication with one or more merchant systems (e.g., merchant system 1208), one or more acquirer systems (e.g., acquirer system 1210), and/or one or more transaction processing systems (e.g., transaction processing system 1202). Although only a single merchant system 1208, a single acquirer system 1210, and a single transaction processing system 1202 are shown, it will be appreciated that payment gateway system 1212 may be in communication with a plurality of merchant systems, a plurality of acquirer systems, and/or a plurality of transaction processing systems. In some non-limiting embodiments or aspects, payment gateway system 1212 may include a computing device, such as a server, a group of servers, and/or other like devices. In some non-limiting embodiments or aspects, payment gateway system 1212 may be associated with a payment gateway, as described herein.

Merchant system 1208 may include one or more devices capable of receiving information from and/or communicating information to transaction processing system 1202, payment gateway system 1212, issuer system 1204, acquirer system 1210, customer device 1206, and/or the like (e.g., directly, indirectly, via a public and/or private communication network connection, and/or the like). For example, as shown in FIG. 12, merchant system 1208 may be in communication with one or more payment gateway systems (e.g., payment gateway system 1212), one or more acquirer systems (e.g., acquirer system 1210), and/or one or more consumer devices (e.g., customer device 1206). Although only a single payment gateway system 1212, a single acquirer system 1210, and a single customer device 1206 are shown, it will be appreciated that merchant system 1208 may be in communication with a plurality of payment gateway systems, a plurality of acquirer systems, and/or a plurality of consumer devices. In some non-limiting embodiments or aspects, merchant system 1208 may include a computing device, such as a server, a group of servers, a client device, a group of client devices, a POS device, a POS system, computers, computer systems, peripheral devices, and/or other like devices. In some non-limiting embodiments or aspects, merchant system 1208 may be associated with a merchant, as described herein. In some non-limiting embodiments or aspects, merchant system 1208 may include a device capable of receiving information from and/or communicating information to customer device 1206 via a short range communication connection (e.g., an NFC communication connection, an RFID communication connection, a Bluetooth® communication connection, a Zigbee® communication connection, and/or the like) with customer device 1206 and/or the like. In some non-limiting embodiments or aspects, merchant system 1208 may include one or more client devices. For example, merchant system 1208 may include a client device that allows a merchant to communicate information to transaction processing system 1202 (e.g., via at least one of acquirer system 1210 and/or payment gateway system 1212). In some non-limiting embodiments or aspects, merchant system 1208 (e.g., a client device thereof, a POS device thereof, and/or the like) may also operate as a payment gateway system, such that both merchant system 1208 and payment gateway system 1212 are a single system and/or controlled by a single entity.

Issuer system 1204 may include one or more devices capable of receiving information and/or communicating information to transaction processing system 1202, payment gateway system 1212, merchant system 1208, acquirer system 1210, customer device 1206, and/or the like (e.g., directly, indirectly, via a public and/or private communication network connection, and/or the like). For example, as shown in FIG. 12, issuer system 1204 may be in communication with one or more transaction processing systems (e.g., transaction processing system 1202) and/or one or more consumer devices (e.g., customer device 1206). Although only a single transaction processing system 1202 and a single customer device 1206 are shown, it will be appreciated that issuer system 1204 may be in communication with a plurality of transaction processing systems and/or a plurality of customer devices 1206. In some non-limiting embodiments or aspects, issuer system 1204 may include a computing device, such as a server, a group of servers, and/or other like devices. In some non-limiting embodiments or aspects, issuer system 1204 may be associated with an issuer institution, as described herein. For example, issuer system 1204 may be associated with an issuer institution that issued a credit account, debit account, credit card, debit card, a payment device, and/or the like to a user associated with customer device 1206.

Acquirer system 1210 may include one or more devices capable of receiving information from and/or communicating information to transaction processing system 1202, payment gateway system 1212, merchant system 1208, issuer system 1204, customer device 1206, and/or the like (e.g., directly, indirectly, via a public and/or private communication network connection, and/or the like). For example, as shown in FIG. 12, acquirer system 1210 may be in communication with one or more transaction processing systems (e.g., transaction processing system 1202), one or more payment gateway systems (e.g., payment gateway system 1212), and/or one or more merchant systems (e.g., merchant system 1208). Although only a single transaction processing system 1202, a single payment gateway system 1212, and a single merchant system 1208 are shown, it will be appreciated that acquirer system 1210 may be in communication with a plurality of transaction processing systems, a plurality of payment gateway systems, and/or a plurality of merchant systems. In some non-limiting embodiments or aspects, acquirer system 1210 may include a computing device, such as a server, a group of servers, and/or other like devices. In some non-limiting embodiments or aspects, acquirer system 1210 may be associated with an acquirer institution, as described herein.

Customer device 1206 may include one or more devices capable of receiving information from and/or communicating information to transaction processing system 1202, payment gateway system 1212, merchant system 1208, issuer system 1204, acquirer system 1210, and/or the like (e.g., directly, indirectly, via a public and/or private communication network connection, and/or the like). For example, as shown in FIG. 12, customer device 1206 may be in communication with one or more merchant systems (e.g., merchant system 1208) and/or one or more issuer systems (e.g., issuer system 1204). Although only a single merchant system 1208 and a single issuer system 1204 are shown, it will be appreciated that customer device 1206 may be in communication with a plurality of merchant systems and/or a plurality of issuer systems. In some non-limiting embodiments or aspects, customer device 1206 may be associated with a user to whom a credit account, debit account, credit card, debit card, a payment device, and/or the like has been issued. In some non-limiting embodiments or aspects, customer device 1206 may include a computing device, such as a computer, a portable computer, a laptop computer, a tablet computer, a mobile device, a cellular phone, a smartphone, a wearable device (e.g., watches, glasses, lenses, clothing, and/or the like), a PDA, a client device, and/or other like devices. In some non-limiting embodiments or aspects, customer device 1206 may include a payment device, as described herein. In some non-limiting embodiments or aspects, customer device 1206 may include a device capable of receiving information from and/or communicating information to other customer devices 1206 (e.g., directly, indirectly, via a public and/or private communication network connection, a short range communication connection, and/or the like). In some non-limiting embodiments or aspects, customer device 1206 may include a device capable of receiving information from and/or communicating information to merchant system 1208 via a short range communication connection (e.g., an NFC communication connection, an RFID communication connection, a Bluetooth® communication connection, a Zigbee® communication connection, and/or the like) with merchant system 1208 and/or the like. In some non-limiting embodiments or aspects, customer device 1206 may include a client device.

In some non-limiting embodiments or aspects, transaction processing system 1202 may communicate with merchant system 1208 directly (e.g., via a public and/or private communication network connection and/or the like). Additionally or alternatively, transaction processing system 1202 may communicate with merchant system 1208 through payment gateway system 1212 and/or acquirer system 1210. In some non-limiting embodiments or aspects, acquirer system 1210 associated with merchant system 1208 may operate as payment gateway system 1212 to facilitate the communication of transaction messages (e.g., authorization requests) from merchant system 1208 to transaction processing system 1202. In some non-limiting embodiments or aspects, merchant system 1208 may communicate with payment gateway system 1212 directly (e.g., via a public and/or private communication network connection and/or the like). For example, merchant system 1208, that includes a physical POS device, may communicate with payment gateway system 1212 through a public or private network to conduct card-present transactions. As another example, merchant system 1208, that includes a server (e.g., a web server), may communicate with payment gateway system 1212 through a public or private network, such as the Internet, to conduct card-not-present transactions.

For the purpose of illustration, processing a transaction (e.g., a payment transaction) may include generating a transaction message (e.g., authorization request and/or the like) based on an account identifier of a customer (e.g., accountholder associated with customer device 1206 and/or the like) and/or transaction data associated with the transaction. For example, merchant system 1208 (e.g., a client device of merchant system 1208, a POS device of merchant system 1208, and/or the like) may initiate the transaction, e.g., by generating an authorization request (e.g., in response to receiving the account identifier from a payment device and/or a portable financial device of the customer and/or the like). Merchant system 1208 may communicate the authorization request to payment gateway system 1212 and/or acquirer system 1210. In some non-limiting embodiments or aspects, payment gateway system 1212 may communicate the authorization request to acquirer system 1210 and/or transaction processing system 1202. Additionally or alternatively, acquirer system 1210 (and/or payment gateway system 1212) may communicate the authorization request to transaction processing system 1202. After receiving the authorization request from merchant system 1208 that identifies the account identifier of the customer (e.g., the accountholder associated with customer device 1206 and/or the account identifier), transaction processing system 1202 may communicate the authorization request to issuer system 1204 (e.g., the issuer system that issued the payment device and/or account identifier). Issuer system 1204 may determine an authorization decision (e.g., approve, deny, and/or the like) based on the authorization request, and/or issuer system 1204 may generate an authorization response based on the authorization decision and/or the authorization request. Issuer system 1204 may communicate the authorization response to transaction processing system 1202. Transaction processing system 1202 may communicate the authorization response to acquirer system 1210 and/or payment gateway system 1212. In some non-limiting embodiments or aspects, acquirer system 1210 may communicate the authorization response to payment gateway system 1212 and/or merchant system 1208. Additionally or alternatively, payment gateway system 1212 (and/or acquirer system 1210) may communicate the authorization response to merchant system 1208.

In some non-limiting embodiments or aspects, transaction processing system 1202 and/or issuer system 1204 may include at least one machine learning model (e.g., a machine learning model as described herein, which includes at least one of a fraud detection model, a risk detection model, a transaction authorization model, a credit approval model, a product recommendation model, a classifier model, an anomaly detection model, an authentication model, any combination thereof, and/or the like). For example, the machine learning model(s) may be trained based on synthetic data generated, as described herein. Transaction processing system 1202 and/or issuer system 1204 may perform at least one task (e.g., generate a prediction and/or generate an embedding) based on the authorization request and the machine learning model(s). For example, performing the task(s) may include generating at least one prediction associated with fraud detection, risk detection, transaction authorization, credit approval, product recommendation, classification, anomaly detection, authentication, any combination thereof, and/or the like. In some non-limiting embodiments or aspects, transaction processing system 1202 may communicate at least one message based on performing the task (e.g., generating the prediction and/or generating an embedding) to issuer system 1204 (e.g., along with the authorization request). In some non-limiting embodiments or aspects, issuer system 1204 may determine the authorization decision (e.g., approve, deny, and/or the like) based on the authorization request and the performance of the task (e.g., generation of the prediction and/or generation of the embedding).

For the purpose of illustration, clearing and/or settlement of a transaction may include generating a message (e.g., clearing message and/or the like) based on an account identifier of a customer (e.g., associated with customer device 1206 and/or the like) and/or transaction data associated with the transaction. For example, merchant system 1208 may generate at least one clearing message (e.g., a plurality of clearing messages, a batch of clearing messages, and/or the like). Merchant system 1208 may communicate the clearing message(s) to acquirer system 1210 (and/or payment gateway system 1212, which may communicate the clearing message(s) to acquirer system 1210). Acquirer system 1210 may communicate the clearing message(s) to transaction processing system 1202. Transaction processing system 1202 may communicate the clearing message(s) to issuer system 1204. Issuer system 1204 may generate at least one settlement message based on the clearing message(s). In some non-limiting embodiments or aspects, issuer system 1204 may communicate the settlement message(s) and/or funds to transaction processing system 1202 (and/or a settlement bank system associated with transaction processing system 1202), and transaction processing system 1202 (and/or the settlement bank system) may communicate the settlement message(s) and/or funds to acquirer system 1210. Additionally or alternatively, issuer system 1204 may communicate the settlement message(s) and/or funds to acquirer system 1210. In some non-limiting embodiments or aspects, acquirer system 1210 may communicate the settlement message(s) and/or funds to merchant system 1208 (and/or an account associated with merchant system 1208).

Communication network 1214 may include one or more wired and/or wireless networks. For example, communication network 1214 may include a cellular network (e.g., a long-term evolution (LTE) network, a third generation (3G) network, a fourth generation (4G) network, a fifth generation (13G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 12 are provided as an example. There may be additional systems, devices, and/or networks; fewer systems, devices, and/or networks; different systems, devices, and/or networks; and/or differently arranged systems, devices, and/or networks than those shown in FIG. 12. Furthermore, two or more systems or devices shown in FIG. 12 may be implemented within a single system or device, or a single system or device shown in FIG. 12 may be implemented as multiple, distributed systems or devices. Additionally or alternatively, a set of systems (e.g., one or more systems) or a set of devices (e.g., one or more devices) of payment processing network 1200 may perform one or more functions described as being performed by another set of systems or another set of devices of payment processing network 1200.

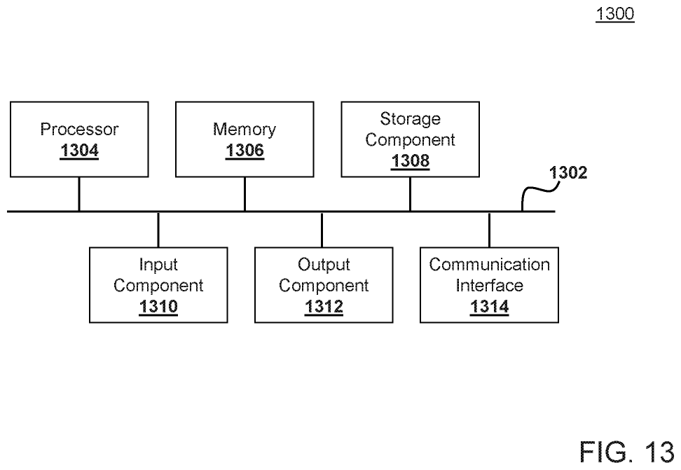

Referring now to FIG. 13, shown is a diagram of example components of device 1300, according to non-limiting embodiments or aspects. Device 1300 may correspond to at least one of ML model management system 102, database 104, user device 106, and/or agent device 108 in FIG. 1 and/or at least one of transaction processing system 1202, issuer system 1204, customer device 406, merchant system 1208, and/or acquirer system 1210 in FIG. 12, as an example. In some non-limiting embodiments or aspects, such systems or devices in FIG. 1 or FIG. 12 may include at least one device 1300 and/or at least one component of device 1300. The number and arrangement of components shown in FIG. 13 are provided as an example. In some non-limiting embodiments or aspects, device 1300 may include additional components, fewer components, different components, or differently arranged components than those shown in FIG. 13. Additionally or alternatively, a set of components (e.g., one or more components) of device 1300 may perform one or more functions described as being performed by another set of components of device 1300.

As shown in FIG. 13, device 1300 may include bus 1302, processor 1304, memory 1306, storage component 1308, input component 1310, output component 1312, and communication interface 1314. Bus 1302 may include a component that permits communication among the components of device 1300. In some non-limiting embodiments or aspects, processor 1304 may be implemented in hardware, firmware, or a combination of hardware and software. For example, processor 1304 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 1306 may include random access memory (RAM), read only memory (ROM), and/or another type of dynamic or static storage device (e.g., flash memory, magnetic memory, optical memory, etc.) that stores information and/or instructions for use by processor 1304.

With continued reference to FIG. 13, storage component 1308 may store information and/or software related to the operation and use of device 1300. For example, storage component 1308 may include a hard disk (e.g., a magnetic disk, an optical disk, a magneto-optic disk, a solid-state disk, etc.) and/or another type of computer-readable medium. Input component 1310 may include a component that permits device 1300 to receive information, such as via user input (e.g., a touch screen display, a keyboard, a keypad, a mouse, a button, a switch, a microphone, etc.). Additionally or alternatively, input component 1310 may include a sensor for sensing information (e.g., a global positioning system (GPS) component, an accelerometer, a gyroscope, an actuator, etc.). Output component 1312 may include a component that provides output information from device 1300 (e.g., a display, a speaker, one or more light-emitting diodes (LEDs), etc.). Communication interface 1314 may include a transceiver-like component (e.g., a transceiver, a separate receiver and transmitter, etc.) that enables device 1300 to communicate with other devices, such as via a wired connection, a wireless connection, or a combination of wired and wireless connections. Communication interface 1314 may permit device 1300 to receive information from another device and/or provide information to another device. For example, communication interface 1314 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 1300 may perform one or more processes described herein. Device 1300 may perform these processes based on processor 1304 executing software instructions stored by a computer-readable medium, such as memory 1306 and/or storage component 1308. A computer-readable medium may include any non-transitory memory device. A memory device includes memory space located inside of a single physical storage device or memory space spread across multiple physical storage devices. Software instructions may be read into memory 1306 and/or storage component 1308 from another computer-readable medium or from another device via communication interface 1314. When executed, software instructions stored in memory 1306 and/or storage component 1308 may cause processor 1304 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

1-23. (canceled)

24. A system comprising:
a data storage device comprising model requirement data;
at least one processor in communication with the data storage device configured to:
retrieve at least one parameter from the model requirement data based on a specified location in the data storage device;
execute at least one machine-learning model based on input data to generate an output;
generate a bias metric based on the output and the at least one parameter;
determine a mitigation procedure based on the bias metric; and
execute the mitigation procedure.

25. The system of claim 24, further comprising:
a software agent configured to retrieve the at least one parameter and execute the at least one machine learning model, wherein the input data is based at least partially on the at least one parameter.

26. The system of claim 24, wherein the at least one processor is further configured to:
automatically re-execute the at least one machine learning model; and
automatically execute an updated mitigation procedure based on updates to the model requirement data.

27. The system of claim 24, wherein the at least one parameter comprises a fairness metric and a performance metric upon which the at least one machine learning model is to be evaluated, and wherein the at least one processor is further configured to:
retrieve information associated with a sensitive attribute information pertinent to a geographic location where the at least one machine learning model will be deployed using retrieval augmented generation (RAG); and
execute a bias detection job as part of a bias detection process to assess the at least one machine learning model against the fairness metric and the performance metric.

28. The system of claim 27, wherein the fairness metric comprises a metric associated with demographic parity difference and the performance metric comprises a metric associated with accuracy.

29. The system of claim 27, wherein, when generating the bias metric, the at least one processor is configured to:
generate the bias metric for the at least one machine learning model based on executing the bias detection job as part of the bias detection process to assess the at least one machine learning model against the fairness metric and the performance metric.

30. The system of claim 24, wherein the at least one processor is further configured to:
display a value associated with the fairness metric and a value associated with the performance metric in a graphical user interface; and
display a recommendation for a mitigation procedure based on the bias metric.

31. A method, comprising:
retrieving, with at least one processor, at least one parameter from model requirement data based on a specified location in a data storage device;
executing, with at least one processor, at least one machine learning model based on input data to generate an output;
generating, with at least one processor, a bias metric based on the output and the at least one parameter;
determining, with at least one processor, a mitigation procedure based on the bias metric; and
executing, with at least one processor, the mitigation procedure.

32. The method of claim 31, wherein retrieving the at least one parameter from the model requirement data comprises
retrieving, with a first software agent, the at least one parameter; and
executing, with a second software agent, the at least one machine learning model, wherein the input data to the at least one machine learning model is based at least partially on the at least one parameter.

33. The method of claim 31, further comprising:
automatically re-executing the at least one machine learning model; and
automatically executing an updated mitigation procedure based on updates to the model requirement data.

34. The method of claim 31, wherein the at least one parameter comprises a fairness metric and a performance metric upon which the at least one machine learning model is to be evaluated, and wherein the method further comprises:
retrieving information associated with a sensitive attribute information pertinent to a geographic location where the at least one machine learning model will be deployed using retrieval augmented generation (RAG); and
executing a bias detection job as part of a bias detection process to assess the at least one machine learning model against the fairness metric and the performance metric.

35. The method of claim 34, wherein the fairness metric comprises a metric associated with demographic parity difference and the performance metric comprises a metric associated with accuracy.

36. The method of claim 34, wherein generating the bias metric comprises:
generating the bias metric for the at least one machine learning model based on executing the bias detection job as part of the bias detection process to assess the at least one machine learning model against the fairness metric and the performance metric.

37. The method of claim 31, further comprising:
displaying a value associated with the fairness metric and a value associated with the performance metric in a graphical user interface (GUI); and
displaying a recommendation for a mitigation procedure based on the bias metric in the GUI.

38. A computer program product, comprising at least one non-transitory computer-readable medium including program instructions that, when executed by at least one processor, cause the at least one processor to:
retrieve at least one parameter from model requirement data based on a specified location in a data storage device;
execute at least one machine-learning model based on input data to generate an output;
generate a bias metric based on the output and the at least one parameter;
determine a mitigation procedure based on the bias metric; and
execute the mitigation procedure.

39. The computer program product of claim 38, wherein the program instructions further cause the at least one processor to:
automatically re-execute the at least one machine learning model and automatically execute an updated mitigation procedure based on updates to the model requirement data.

40. The computer program product of claim 38, wherein the at least one parameter comprises a fairness metric and a performance metric upon which the at least one machine learning model is to be evaluated, and wherein the program instructions further cause the at least one processor to:
retrieve information associated with a sensitive attribute information pertinent to a geographic location where the at least one machine learning model will be deployed using retrieval augmented generation (RAG); and
execute a bias detection job as part of a bias detection process to assess the at least one machine learning model against the fairness metric and the performance metric.

41. The computer program product of claim 40, wherein the fairness metric comprises a metric associated with demographic parity difference and the performance metric comprises a metric associated with accuracy.

42. The computer program product of claim 40, wherein, the program instructions that cause the at least one processor to generate the bias metric, cause the at least one processor to:
generate the bias metric for the at least one machine learning model based on executing the bias detection job as part of the bias detection process to assess the at least one machine learning model against the fairness metric and the performance metric.

43. The computer program product of claim 38, wherein the program instructions further cause the at least one processor to:
display a value associated with the fairness metric and a value associated with the performance metric in a graphical user interface; and
display a recommendation for a mitigation procedure based on the bias metric.
